(19) United States
(12) Patent Application Publication
(10) Pub. No.: US 2026/0159395 A1
(43) Pub. Date: Jun. 11, 2026

(54) PROCESS FOR THE PREPARATION OF ELECTROACTIVE COMPOSITE PARTICLES

(71) Applicant: NEXEON LIMITED, Abingdon Oxfordshire (GB)

(72) Inventors: Charles MASON, Abingdon Oxfordshire (GB); Joshua WHITTAM, Abingdon Oxfordshire (GB); Silo MEOTO, Abingdon Oxfordshire (GB); Kseniia KATOK, Abingdon Oxfordshire (GB); Judit SERRA MORENO, Abingdon Oxfordshire (GB)

(21) Appl. No.: 19/125,956

(22) PCT Filed: Oct. 31, 2023
(86) PCT No.: PCT/GB2023/052845

§ 371 Date: Apr. 30, 2025

(30) Foreign Application Priority Data
Oct. 31, 2022 (GB) 2216146.7

(51) Int. Cl. C01B 32/05

(52) U.S. Cl. CPC C01B 32/05; C01P 2002/88; C01P 2004/80; C01P 2006/14; C01P 2006/16

(57) ABSTRACT

The invention relates to a process for preparing composite particles. The process comprises the steps of providing a plurality of porous particles comprising micropores and/or mesopores; contacting the porous particles with a silicon-containing precursor at a temperature effective to cause deposition of a plurality of silicon domains in the pores of the porous particles; and subjecting the particles to heat treatment at a temperature of at least 400° C. and in the presence of an inert gas.

### INTRODUCTION

This invention relates to a process for the preparation of composite particles comprising an electroactive material deposited into the pores of a porous particle framework. The process of the invention involves in particular a step of thermal post-treatment of the composite particles to improve electrochemical performance when the composite particles are used as anode active materials in rechargeable lithium-ion batteries.

### BACKGROUND TO THE INVENTION

Lithium-ion batteries (LIBs) comprise in general an anode, a cathode and a lithium-containing electrolyte. The anode generally comprises a metal current collector provided with a layer of an electroactive material, defined herein as a material which is capable of inserting and releasing lithium ions during the charging and discharging of a battery. When a LIB is charged, lithium ions are transported from the cathode via the electrolyte to the anode and are inserted into the electroactive material of the anode as intercalated lithium atoms. The terms “cathode” and “anode” are therefore used herein in the sense that the battery is placed across a load, such that the anode is the negative electrode. The term “battery” is used herein to refer both to devices containing a single lithium-ion cell and to devices containing multiple connected lithium-ion cells.

LIBs were developed in the 1980s and 1990s and have since found wide application in portable electronic devices. The development of electric or hybrid vehicles in recent has created a significant new market for LIBs and renewable energy sources have created further demand for on-grid energy storage which can be met at least in part by LIB farms. Overall, global production of LIBs is projected to grow from around 290 GWh in 2018 to over 2,000 GWh in 2028.

Alongside the growth in total storage capacity, there is significant interest in improving the gravimetric and/or volumetric capacities of rechargeable metal-ion batteries such that the same energy storage is achieved with less battery mass and/or less battery volume. Conventional LIBs use graphite as the anode electroactive material. Graphite anodes can accommodate a maximum of one lithium atom for every six carbon atoms resulting in a maximum theoretical specific capacity of 372 mAh/g in a lithium-ion battery, with a practical capacity that is somewhat lower (ca. 340 to 360 mAh/g).

Silicon is a promising alternative to graphite because of its very high capacity for lithium (see, for example, Insertion Electrode Materials for Rechargeable Lithium Batteries, Winter, M. et al. in Adv. Mater. 1998, 10, No. 10). Silicon has a theoretical maximum specific capacity of about 3,600 mAh/g in a lithium-ion battery (based on Li₁₅Si₄).

However, such a high ratio of intercalated lithium to silicon results in expansion of the silicon material by up to 400% of its original volume. Repeated charging and discharging cycles result in significant mechanical stress on the silicon material leading to fracturing and structural failure. Furthermore, the charging of anodes in LIBs results in the formation of a solid electrolyte interphase (SEI) layer. This SEI layer is an ion-conductive yet insulating layer that is formed by the reductive decomposition of electrolytes on exposed electrode surfaces during the initial charge. In a graphite anode, this SEI layer is relatively stable during subsequent charge/discharge cycles. However, the expansion and contraction of a silicon anode results in fracturing and delamination of the SEI layer and the exposure of fresh silicon surface, resulting in further electrolyte decomposition, increased thickness of the SEI layer and irreversible consumption of lithium. These failure mechanisms collectively result in an unacceptable loss of electrochemical capacity over successive charging and discharging cycles.

The present inventors have previously reported the development of a class of electroactive materials having a composite structure in which electroactive materials, such as silicon, are deposited into the pore network of highly porous particles, e.g. a porous carbon material, having a carefully controlled pore size distribution. For example, WO 2020/095067 and WO 2020/128495 report that the improved electrochemical performance of these materials can be attributed to the way in which the electroactive materials form small domains with dimensions of the order of a few nanometres or less within the pore network of the porous particles, which thus function as a framework for the composite particles. The fine electroactive structures are thought to have a lower resistance to elastic deformation and higher fracture resistance than larger electroactive structures, and are therefore able to lithiate and delithiate without excessive structural stress. As a result, the electroactive materials exhibit good reversible capacity retention over multiple charge-discharge cycles. Secondly, by controlling the loading of silicon within the porous carbon framework such that only part of the pore volume is occupied by silicon in the uncharged state, the unoccupied pore volume of the porous carbon framework is able to accommodate a substantial amount of silicon expansion internally. Excessive expansion is constrained by the particle framework. Furthermore, only a small area of the electroactive material surface is accessible to electrolyte and so SEI formation is substantially prevented.

In WO 2022/029422, the applicant has reported a further development in which control of the distribution of electroactive silicon within the pore network of the particle framework results in still a further improvement in the electrochemical performance of the composite particles. Specifically, the applicant has shown that electrochemical performance is optimised when the length scale of the individual silicon structures in the composite particles is minimised such that a large proportion of the silicon atoms are in a surface region of the silicon structures, with a relatively smaller proportion of silicon atoms located inside bulky/coarse silicon structures. The applicant has identified an optimised pore structure of the porous particle framework and a set of conditions for the deposition of silicon into the porous particle framework that allows for an increased proportion of this so-called “surface silicon” while also ensuring a large amount of silicon in total is incorporated into the composite particles to meet overall volumetric energy density requirements.

There remains a need in the art for further improvements to electroactive composite particles of the type described above to provide improvements in electrochemical performance and longevity of the materials over multiple charge discharge cycles.

### SUMMARY OF THE INVENTION

In a first aspect, the invention provides a process for preparing composite particles, the process comprising the steps of:
(a) providing a plurality of porous particles comprising micropores and/or mesopores;
(b) contacting the porous particles with a silicon-containing precursor at a temperature effective to cause deposition of a plurality of nanoscale silicon domains in the pores of the porous particles;
(c) subjecting the particles from step (b) to heat treatment at a temperature of at least 400° C. and in the presence of an inert gas.

The invention therefore relates in general terms to a process for preparing composite particles in which thermal decomposition of a silicon-containing precursor material is used to deposit a plurality of nanoscale silicon domains into the pore network of microporous and/or mesoporous porous particles. The composite particles produced according to the process of the invention therefore comprise a first component in the form of porous particle framework that is derived from the porous particles provided in step (a), and a second component in the form of a plurality of nanoscale silicon domains that are deposited within the pore structure of the porous particle framework in step (b). As used herein, the term “nanoscale silicon domain” refers to a nanoscale body of elemental silicon having maximum dimensions that are determined by the location of the silicon within the micropores and/or mesopores of the porous particles.

The process of the invention builds upon prior disclosures by the applicant by the addition of a thermal treatment step to processes for the formation of silicon-containing composite particles that comprise a plurality of silicon domains in the pores of a microporous and/or mesoporous particle.

The deposition of silicon nanoscale domains in mesoporous and/or microporous particles is kinetically controlled such that thermal deposition takes place preferentially at the internal pore surfaces of the porous particles. The present inventors have identified that nanoscale silicon domains formed in this way are thermodynamically unstable/metastable due to a range of unbalanced bonding interactions of silicon atoms in the surface regions of the nanoscale silicon domains. The thermal treatment of the particles in step (c) of the process of the invention is associated with a number of interrelated thermally-induced processes that stabilize the silicon material and prolong the cycle-life of the composite particles in LIBs.

The nanoscale silicon domains formed by thermal decomposition of a silicon-containing precursor are thought to be in the form of nanoclusters of silicon atoms that are substantially terminated by silicon-hydrogen bonds (Si—H). The surfaces of these nanoclusters are highly reactive, particularly due to elimination of hydrogen and the resulting instability of silicon atoms having free valencies. The thermal treatment of the particles in step (c) is thought to promote the elimination of hydrogen and the solid-state rearrangement of the silicon atoms, thereby reducing the density of unstable and reactive Si—H bonds and promoting the formation of more thermodynamically stable Si—Si bonds.

The rearrangement of the silicon atoms further contributes to the volumetric contraction of the silicon domains. One result of this is that pore spaces that were previously obstructed or capped by silicon nanostructures are reopened such that passivating gases and other functional gases can access the remaining pore volume. The increased access of passivating gases to the residual pore spaces allows a more extensive passivation of the silicon surfaces, while the elimination of hydrogen from silicon nanostructures in previously inaccessible pore spaces reduces the evolution of hydrogen during charging and discharging.

As well as the formation of Si—Si bonds, the thermal treatment in step (c) is also thought to promote the formation of covalent bonds between silicon and the internal surfaces of the porous particle framework (e.g. Si—C bonds in the case that the porous particle framework is a porous carbon particle framework). These bonding interactions between the nanoscale silicon domains and the porous particle framework are believed to improve the mechanical stabilization of the silicon during charging and discharging, in particular by improving the constraining effect of the porous particle framework on excessive expansion of the silicon.

Other effects of the thermal treatment in step (c) are believed to include reduction in the surface area of the nanoscale silicon domains which reduces the reactivity of the silicon with electrolyte and therefore the formation of SEI layers, as well as elimination of surface contaminants.

All of these factors are found to contribute to improved stability of the electroactive material during charging and discharging and therefore to an improvement in the cycle life of lithium ion batteries comprising the particulate material as an anode active material.

In a second aspect, the invention provides a particulate material consisting of a plurality of composite particles obtainable by the process of the first aspect.

In a third aspect, the invention provides a composition comprising the particulate material of the second aspect and at least one other component.

In a fourth aspect, the invention provides an electrode comprising the particulate material of the second aspect or the composition of the third aspect.

In a fifth aspect, the invention provides a rechargeable metal-ion battery comprising the electrode of the fourth aspect.

### BRIEF DESCRIPTION OF DRAWINGS

FIG. 1 is a graph demonstrating the effect of the heat treatment of step (c) on the total volume of micropores and mesopores of composite particles obtained from chemical vapour infiltration of silicon into the pores of porous particles.

FIG. 2 is a graph demonstrating the effect of the heat treatment of step (c) and passivation of step (d) on the total volume of micropores and mesopores of composite particles obtained from chemical vapour infiltration of silicon into the pores of porous particles.

### DETAILED DESCRIPTION OF THE INVENTION

The process of the first aspect of the invention comprises the steps of:
(a) providing a plurality of porous particles comprising micropores and/or mesopores;
(b) contacting the porous particles with a silicon-containing precursor at a temperature effective to cause deposition of a plurality of nanoscale silicon domains in the pores of the porous particles;
(c) subjecting the particles from step (b) to heat treatment at a temperature of at least 400° C. and in the presence of an inert gas.

The porous particles function as a framework for the electroactive material, which is typically deposited in the form of a plurality of electroactive material domains. the term “electroactive material domain” refers to a body of electroactive material, e.g. elemental silicon, having maximum dimensions that are determined by the dimensions of the micropores and/or mesopores of the porous particles in which they are located. The electroactive domains may therefore be described as nanoscale electroactive domains, wherein the term “nanoscale” is understood to refer generally to dimensions less than 100 nm. Although, due to the dimensions of micropores and mesopores, the electroactive material domains typically have maximum dimensions in any direction of less than 50 nm, and usually significantly less than 50 nm. A domain may for example take the form of a regular or irregular particle or a bounded layer or region of coating.

The porous particles generally comprise a three-dimensionally interconnected open pore network comprising micropores and/or mesopores and optionally a minor volume of macropores. In accordance with conventional IUPAC terminology, the term “micropore” is used herein to refer to pores of less than 2 nm in diameter, the term “mesopore” is used herein to refer to pores of 2-50 nm in diameter, and the term “macropore” is used to refer to pores of greater than 50 nm diameter.

References herein to the volume of micropores, mesopores and macropores in the porous particles, and also any references to the distribution of pore volume within the porous particles, relate to the internal pore volume of the porous particles used as the starting material in step (a) of the claimed process, i.e. prior to deposition of electroactive material into the pore volume in step (b).

The porous particles may be characterised by the total volume of micropores and mesopores (i.e. the total pore volume in the pore diameter range from 0 to 50 nm). Typically, the porous particles include both micropores and mesopores. However, it is not excluded that porous particles may be used which include micropores and no mesopores, or mesopores and no micropores.

The total volume of micropores and mesopores in the porous particles is preferably at least 0.4 cm³/g, or at least 0.5 cm³/g, or at least 0.6 cm³/g, or at least 0.65 cm³/g, or at least 0.7 cm³/g, or at least 0.75 cm³/g, or at least 0.8 cm³/g. The use of higher porosity particles may be advantageous since it allows a larger amount of electroactive material to be accommodated within the pore volume.

The internal pore volume of the porous particles is suitably capped at a value at which increasing fragility of the particles structure outweighs the advantage of increased pore volume accommodating a larger amount of electroactive material. Preferably, the total volume of micropores and mesopores in the porous particles is no more than 1.8 cm³/g, or no more than 1.7 cm³/g, or no more than 1.6 cm³/g, or no more than 1.55 cm³/g, or no more than 1.5 cm³/g, or no more than 1.45 cm³/g, or no more than 1.4 cm³/g, or no more than 1.35 cm³/g, or no more than 1.3 cm³/g, or no more than 1.25 cm³/g, or no more than 1.2 cm³/g, or no more than 1.1 cm³/g.

Preferably the total volume of micropores and mesopores in the porous particles is in the range from 0.4 to 1.8 cm³/g, or from 0.4 to 1.7 cm³/g, or from 0.5 to 1.6 cm³/g, or from 0.5 to 1.55 cm³/g, or from 0.6 to 1.5 cm³/g, or from 0.6 to 1.45 cm³/g, or from 0.65 to 1.4 cm³/g, or from 0.65 to 1.35 cm³/g, or from 0.7 to 1.3 cm³/g, or from 0.7 to 1.25 cm³/g, or from 0.75 to 1.2 cm³/g, or from 0.75 to 1.1 cm³/g, or from 0.8 to 1.2 cm³/g, or from 0.8 to 1.1 cm³/g.

The general term “PDₙ pore diameter” refers herein to the volume-based nth percentile pore diameter, based on the total volume of micropores and mesopores. For instance, the term “PD₅₀ pore diameter” as used herein refers to the pore diameter below which 50% of the total micropore and mesopore volume is found. For the avoidance of doubt, any macropore volume (pore diameter greater than 50 nm) is not taken into account for the purpose of determining PDₙ values.

The PD₉₀ pore diameter of the porous particles is preferably no more than 20 nm, or no more than 15 nm, or no more than 12 nm, or no more than 10 nm, or no more than 8 nm, or no more than 6 nm, or no more than 5 nm. Preferably, the PD₉₀ pore diameter of the porous particles is at least 3 nm, or at least 4 nm, or at least 5 nm, or at least 6 nm. For example, the PD₉₀ pore diameter of the porous particles is preferably in the range from 3 to 20 nm, or from 4 to 15 nm, or from 5 to 10 nm, or from 6 to 8 nm.

The PD₅₀ pore diameter of the porous particles is preferably no more than 10 nm, or no more than 8 nm, or no more than 6 nm, or no more than 5 nm, or no more than 4 nm, or no more than 3 nm, or no more than 2.5 nm, or no more than 2 nm, or no more than 1.9 nm, or no more than 1.8 nm, or no more than 1.7 nm, or no more than 1.6 nm. The micropore volume fraction is at least 0.4, or at least 0.45, or at least 0.5, or at least 0.55, or at least 0.6, based on the total volume of micropores and mesopores in the porous particles.

The pore size distribution of the porous particles may be monomodal, bimodal or multimodal. As used herein, the term “pore size distribution” relates to the distribution of pore size relative to the cumulative total internal pore volume of the porous particles. A bimodal or multimodal pore size distribution may be preferred since close proximity between micropores and pores of larger diameter provides the advantage of efficient ionic transport through the porous network to the electroactive material.

The total volume of micropores and mesopores and the pore size distribution of micropores and mesopores are determined using nitrogen gas adsorption at 77 K down to a relative pressure p/p₀ of 10⁻⁶ using quenched solid density functional theory (QSDFT) in accordance with standard methodology as set out in ISO 15901-2 and ISO 15901-3. Nitrogen gas adsorption is a technique that characterises the porosity and pore diameter distributions of a material by allowing a gas to condense in the pores of a solid. As pressure increases, the gas condenses first in the pores of smallest diameter and the pressure is increased until a saturation point is reached at which all of the pores are filled with liquid. The nitrogen gas pressure is then reduced incrementally, to allow the liquid to evaporate from the system. Analysis of the adsorption and desorption isotherms, and the hysteresis between them, allows the pore volume and pore size distribution to be determined. Suitable instruments for the measurement of pore volume and pore size distributions by nitrogen gas adsorption include the TriStar II and TriStar II Plus porosity analyzers, which are available from Micromeritics Instrument Corporation, USA, and the Autosorb IQ porosity analyzers, which are available from Quantachrome Instruments.

Nitrogen gas adsorption is effective for the measurement of pore volume and pore size distributions for pores having a diameter up to 50 nm, but is less reliable for pores of much larger diameter. For the purposes of the present invention, nitrogen adsorption is therefore used to determine pore volumes and pore size distributions only for pores having a diameter up to and including 50 nm (i.e. only for micropores and mesopores). PD₅₀ values are likewise determined relative to the total volume of micropores and mesopores only.

In view of the limitations of available analytical techniques it is not possible to measure pore volumes and pore size distributions across the entire range of micropores, mesopores and macropores using a single technique. In the case that the porous particles comprise macropores, the volume of pores having diameter in the range from greater than 50 nm and up to 100 nm may be measured by mercury porosimetry and is preferably no more than 0.3 cm³/g, or no more than 0.2 cm³/g, or no more than 0.1 cm³/g, or no more than 0.05 cm³/g. A small fraction of macropores may be useful to facilitate electrolyte access into the pore network, but the advantages of the invention are obtained substantially by accommodating electroactive material in micropores and smaller mesopores.

Any pore volume measured by mercury porosimetry at pore sizes of 50 nm or below is disregarded (as set out above, nitrogen adsorption is used to characterize the mesopores and micropores). Pore volume measured by mercury porosimetry above 100 nm is assumed for the purposes of the invention to be inter-particle porosity and is also disregarded.

Mercury porosimetry is a technique that characterizes the porosity and pore diameter distributions of a material by applying varying levels of pressure to a sample of the material immersed in mercury. The pressure required to intrude mercury into the pores of the sample is inversely proportional to the size of the pores. Values obtained by mercury porosimetry as reported herein are obtained in accordance with ASTM UOP578-11, with the surface tension y taken to be 480 mN/m and the contact angle φ taken to be 140° for mercury at room temperature. The density of mercury is taken to be 13.5462 g/cm³ at room temperature. A number of high precision mercury porosimetry instruments are commercially available, such as the AutoPore IV series of automated mercury porosimeters available from Micromeritics Instrument Corporation, USA. For a complete review of mercury porosimetry reference may be made to P. A. Webb and C. Orr in “Analytical Methods in Fine Particle Technology, 1997, Micromeritics Instrument Corporation, ISBN 0-9656783-0.

It will be appreciated that intrusion techniques such as gas adsorption and mercury porosimetry are effective only to determine the pore volume of pores that are accessible to nitrogen or to mercury from the exterior of the porous particles. Porosity values specified herein shall be understood as referring to the volume of open pores, i.e. pores that are accessible to a fluid from the exterior of the porous particles. Fully enclosed pores which cannot be identified by nitrogen adsorption or mercury porosimetry shall not be taken into account herein when determining porosity values. Likewise, any pore volume located in pores that are so small as to be below the limit of detection by nitrogen adsorption is not taken into account.

The term “particle diameter” as used herein refers to the equivalent spherical diameter (esd), i.e. the diameter of a sphere having the same volume as a given particle, wherein the particle volume is understood to include the volume of any intra-particle pores. The terms “D₅₀” and “D₅₀ particle diameter” as used herein refer to the volume-based median particle diameter, i.e. the diameter below which 50% by volume of the particle population is found. The terms “D₁₀” and “D₁₀ particle diameter” as used herein refer to the 10th percentile volume-based median particle diameter, i.e. the diameter below which 10% by volume of the particle population is found. The terms “Do” and “Do particle diameter” as used herein refer to the 90th percentile volume-based median particle diameter, i.e. the diameter below which 90% by volume of the particle population is found.

Particle diameters and particle size distributions can be determined by standard laser diffraction techniques in accordance with ISO 13320:2009. Laser diffraction relies on the principle that a particle will scatter light at an angle that varies depending on the size the particle and a collection of particles will produce a pattern of scattered light defined by intensity and angle that can be correlated to a particle size distribution. A number of laser diffraction instruments are commercially available for the rapid and reliable determination of particle size distributions. Unless stated otherwise, particle size distribution measurements as specified or reported herein are as measured by the conventional Malvern Mastersizer™ 3000 particle size analyzer from Malvern Instruments™. The Malvern Mastersizer™ 3000 particle size analyzer operates by projecting a helium-neon gas laser beam through a transparent cell containing the particles of interest suspended in an aqueous solution. Light rays which strike the particles are scattered through angles which are inversely proportional to the particle size and a photodetector array measures the intensity of light at several predetermined angles and the measured intensities at different angles are processed by a computer using standard theoretical principles to determine the particle size distribution. Laser diffraction values as reported herein are obtained using a wet dispersion of the particles in 2-propanol with a 5 vol % addition of the surfactant SPAN™-40 (sorbitan monopalmitate). The particle refractive index is taken to be 2.68 for porous particles and 3.50 for composite particles and the dispersant index is taken to be 1.378. Particle size distributions are calculated using the Mie scattering model.

In general, the porous particles have a D₅₀ particle diameter in the range from 1 to 30 μm. Optionally, the D₅₀ particle diameter of the porous particles may be at least 1 μm, or at least 1.5 μm, or at least 2 μm, or at least 2.5 μm, or at least 3 μm, or at least 4 μm, or at least 5 μm. Optionally the D₅₀ particle diameter of the porous particles may be no more than 25 μm, or no more than 20 μm, or no more than 18 μm, or no more than 15 μm, or no more than 12 μm, or no more than 10 μm, or no more than 8 μm.

The D₁₀ particle diameter of the porous particles is preferably at least 0.5 μm, or at least 0.8 μm, or at least 1 μm, or at least 1.5 μm, or at least 2 μm. By maintaining the D₁₀ particle diameter at 0.5 μm or more, the potential for undesirable agglomeration of sub-micron sized particles is reduced, and improved dispersibility of the composite particles formed.

The D₉₀ particle diameter of the porous particles is preferably no more than 50 μm, or no more than 40 μm, or no more than 30 μm, or no more than 25 μm, or no more than 20 μm, or no more than 15 μm.

The porous particles preferably have a narrow size distribution span. For instance, the particle size distribution span (defined as (D₉₀-D₁₀)/D₅₀) is preferably 5 or less, more preferably 4 or less, more preferably 3 or less, more preferably 2 or less, and most preferably 1.5 or less. By maintaining a narrow size distribution span, efficient packing of the particles into dense powder beds is more readily achievable.

The porous particles may have an average sphericity (as defined herein) of more than 0.5. Preferably they have an average sphericity of at least 0.55, or at least 0.6, or at least 0.65, or at least 0.7, or at least 0.75, or at least 0.8, or at least 0.85. Preferably, the porous particles have an average sphericity of at least 0.90, or at least 0.92, or at least 0.93, or at least 0.94, or at least 0.95. Spherical particles are believed to aid uniformity of deposition and facilitate denser packing both in the batch pressure reactor and of the final product when incorporated into electrodes.

It is possible to obtain highly accurate two-dimensional projections of micron scale particles by scanning electron microscopy (SEM) or by dynamic image analysis, in which a digital camera is used to record the shadow projected by a particle. The term “sphericity” as used herein shall be understood as the ratio of the area of the particle projection (obtained from such imaging techniques) to the area of a circle, wherein the particle projection and circle have identical circumference. Thus, for an individual particle, the sphericity S may be defined as:

$$S = \frac{4 \cdot π \cdot {A}_{m}}{{( {C}_{m} )}^{2}}$$

wherein Aₘ is the measured area of the particle projection and Cₘ is the measured circumference of the particle projection. The average sphericity Sₐᵥ of a population of particles as used herein is defined as:

$${S}_{av} = \frac{1}{n} {\sum }_{i = 1}^{n} [ \frac{4 \cdot π \cdot {A}_{m}}{{( {C}_{m} )}^{2}} ]$$

wherein n represents the number of particles in the population. The average sphericity for a population of particles is preferably calculated from the two-dimensional projections of at least 50 particles.

The porous particles preferably have a BET surface area of at least 100 m²/g, or at least 500 m²/g, or at least 750 m²/g, or at least 1,000 m²/g, or at least 1,250 m²/g, or at least 1,500 m²/g. The term “BET surface area” as used herein should be taken to refer to the surface area per unit mass calculated from a measurement of the physical adsorption of gas molecules on a solid surface, using the Brunauer-Emmett-Teller theory, in accordance with ISO 9277. Preferably, the BET surface area of the porous particles is no more than 4,000 m²/g, or no more than 3,500 m²/g, or no more than 3,250 m²/g, or no more than 3,000 m²/g or no more than 2,500 m²/g, or no more than 2,000 m²/g. For example, the porous particles may have a BET surface area in the range from 100 m²/g to 4,000 m²/g, or from 500 m²/g to 4,000 m²/g, or from 750 m²/g to 3,500 m²/g, or from 1,000 m²/g to 3,250 m²/g, or from 1,000 m²/g to 3,000 m²/g, or from 1,000 m²/g to 2,500 m²/g, or from 1,000 m²/g to 2,000 m²/g.

The porous particles preferably have a particle density of at least 0.35 and preferably less than 3 g/cm³, more preferably less than 2 g/cm³, more preferably less than 1.5 g/cm³, most preferably from 0.35 to 1.2 g/cm³. As used herein, the term “particle density” refers to “apparent particle density” as measured by mercury porosimetry (i.e. the mass of a particle divided by the particle volume wherein the particle volume is taken to be the sum of the volume of solid material and any closed or blind pores (a “blind pore” is pore that is too small to be measured by mercury porosimetry). Preferably, the porous particles have particle density of at least 0.4 g/cm³, or at least 0.45 g/cm³, or at least 0.5 g/cm³, or at least 0.55 g/cm³, or at least 0.6 g/cm³, or at least 0.65 g/cm³, or at least 0.7 g/cm³. Preferably, the porous particles have particle density of no more than 1.15 g/cm³, or no more than 1.1 g/cm³, or no more than 1.05 g/cm³, or no more than 1 g/cm³, or no more than 0.95 g/cm³, or no more than 0.9 g/cm³.

Preferably the porous particles have:
(i) a total pore volume of micropores and mesopores as measured by nitrogen gas adsorption in the range from 0.4 to 1.8 cm³/g;
(ii) a PD₅₀ pore diameter of no more than 10 nm, and preferably a PD₉₀ pore diameter of no more than 20 nm; and
(iii) a D₅₀ particle diameter in the range from 1 to 30 μm.

More preferably the porous particles have:
(i) a total pore volume of micropores and mesopores as measured by nitrogen gas adsorption in the range from 0.5 to 1.6 cm³/g;
(ii) a PD₅₀ pore diameter of no more than 8 nm, and preferably a PD₉₀ pore diameter of no more than 15 nm; and
(iii) a D₅₀ particle diameter in the range from 1 to 25 μm.

More preferably the porous particles have:
(i) a total pore volume of micropores and mesopores as measured by nitrogen gas adsorption in the range from 0.6 to 1.5 cm³/g;
(ii) a PD₅₀ pore diameter of no more than 6 nm, and preferably a PD₉₀ pore diameter of no more than 12 nm; and
(iii) a D₅₀ particle diameter in the range from 1.5 to 20 μm.

More preferably the porous particles have:
(i) a total pore volume of micropores and mesopores as measured by nitrogen gas adsorption in the range from 0.65 to 1.4 cm³/g;
(ii) a PD₅₀ pore diameter of no more than 2.5 nm, and preferably a PD₉₀ pore diameter of no more than 10 nm; and
(iii) a D₅₀ particle diameter in the range from 1.5 to 18 μm.

More preferably the porous particles have:
(i) a total pore volume of micropores and mesopores as measured by nitrogen gas adsorption in the range from 0.7 to 1.3 cm³/g;
(ii) a PD₅₀ pore diameter of no more than 4 nm, and preferably a PD₉₀ pore diameter of no more than 8 nm; and
(iii) a D₅₀ particle diameter in the range from 2 to 15 μm.

More preferably the porous particles have:
(i) a total pore volume of micropores and mesopores as measured by nitrogen gas adsorption in the range from 0.75 to 1.2 cm³/g;
(ii) a PD₅₀ pore diameter of no more than 3 nm, and preferably a PD₉₀ pore diameter of no more than 6 nm; and
(iii) a D₅₀ particle diameter in the range from 2 to 12 μm.

More preferably the porous particles have:
(i) a total pore volume of micropores and mesopores as measured by nitrogen gas adsorption in the range from 0.8 to 1.2 cm³/g;
(ii) a PD₅₀ pore diameter of no more than 2 nm, and preferably a PD₉₀ pore diameter of no more than 5 nm; and
(iii) a D₅₀ particle diameter in the range from 2.5 to 10 μm.

The porous particles preferably comprise a conductive material. The use of conductive porous particles is advantageous as the porous particles form a conductive framework within the composite particles which facilitates the flow of electrons between lithium atoms/ions inserted into the electroactive material and a current collector.

A preferred type of conductive porous particles are particles comprising or consisting of a conductive carbon material, referred to herein as conductive porous carbon particles.

The conductive porous carbon particles preferably comprise at least 80 wt % carbon, more preferably at least 85 wt % carbon, more preferably at least 90 wt % carbon, more preferably at least 95 wt % carbon, and optionally at least 98 wt % or at least 99 wt % carbon. The carbon may be crystalline carbon or amorphous carbon, or a mixture of amorphous and crystalline carbon. The porous carbon particles may be either hard carbon particles or soft carbon particles.

As used herein, the term “hard carbon” refers to a disordered carbon matrix in which carbon atoms are found predominantly in the sp² hybridised state (trigonal bonds) in nanoscale polyaromatic domains. The polyaromatic domains are cross-linked with a chemical bond, e.g. a C—O—C bond. Due to the chemical cross-linking between the polyaromatic domains, hard carbons cannot be converted to graphite at high temperatures. Hard carbons have graphite-like character as evidenced by the large G-band (˜1600 cm⁻¹) in the Raman spectrum. However, the carbon is not fully graphitic as evidenced by the significant D-band (˜1350 cm⁻¹) in the Raman spectrum.

As used herein, the term “soft carbon” also refers to a disordered carbon matrix in which carbon atoms are found predominantly in the sp² hybridised state (trigonal bonds) in polyaromatic domains having dimensions in the range from 5 to 200 nm. In contrast to hard carbons, the polyaromatic domains in soft carbons are associated by intermolecular forces but are not cross-linked with a chemical bond. This means that they will graphitise at high temperature. The porous carbon particles preferably comprise at least 50% sp² hybridised carbon as measured by XPS. For example, the porous carbon particles may suitably comprise from 50% to 98% sp² hybridised carbon, from 55% to 95% sp² hybridised carbon, from 60% to 90% sp² hybridised carbon, or from 70% to 85% sp² hybridised carbon.

A variety of different materials may be used to prepare suitable porous carbon particles via pyrolysis. Examples of organic materials that may be used include plant biomass including lignocellulosic materials (such as coconut shells, rice husks, wood etc.) and fossil carbon sources such as coal. Examples of resins and polymeric materials which form porous carbon particles on pyrolysis include phenolic resins, novolac resins, pitch, melamines, polyacrylates, polystyrenes, polyvinylalcohol (PVA), polyvinylpyrrolidone (PVP), and various copolymers comprising monomer units of acrylates, styrenes, α-olefins, vinyl pyrrolidone and other ethylenically unsaturated monomers. A variety of different carbon materials are available in the art depending on the starting material and the conditions of the pyrolysis process. Porous carbon particles of various different specifications are available from commercial suppliers.

Porous carbon particles may undergo a chemical or gaseous activation process to increase the volume of mesopores and micropores. A suitable activation process comprises contacting pyrolyzed carbon with one or more of oxygen, steam, CO, CO₂ and KOH at a temperature in the range from 600 to 1000° C.

Mesopores can also be obtained by known templating processes, using extractable pore formers such as MgO and other colloidal or polymer templates which can be removed by thermal or chemical means post pyrolysis or activation.

Alternatives to carbon-based conductive particles include porous particles comprising titanium nitride (TiN), titanium carbide (TiC), silicon carbide (SiC), nickel oxide (NiOx), titanium silicon nitride (TiSiN), nickel nitride (Ni₃N), molybdenum nitride (MoN), titanium oxynitride (TiOₓN₁₋ₓ), silicon oxycarbide (SiOC), boron nitride (BN), or vanadium nitride (VN). Preferably the porous particles comprise titanium nitride (TiN), silicon oxycarbide (SiOC) or boron nitride (BN).

The composite particles of the invention are suitably prepared via chemical vapor infiltration (CVI) of a gaseous silicon-containing precursor into the pore structure of the porous particles. As used herein, CVI refers to processes in which a gaseous silicon-containing precursor is thermally decomposed on a surface to form elemental silicon at the surface and gaseous by-products.

Suitable gaseous silicon-containing precursors include silane (SiH₄), disilane (Si₂H₆), trisilane (Si₃H₈), tetrasilane (Si₄H₁₀), methylsilane (CH₃SiH₃), dimethylsilane ((CH₃)₂SiH₂), or chlorosilanes such as trichlorosilane (HSiCl₃) or methylchlorosilanes such as methyltrichlorosilane (CH₃SiCl₃) or dimethyldichlorosilane ((CH₃)₂SiCl₂). Preferably the silicon-containing precursor is selected from the group consisting of silane (SiH₄), disilane (Si₂H₆), trisilane (Si₃H₈), tetrasilane (Si₄H₁₀). A particularly preferred precursor of silicon is silane.

In the case that the precursor is a chlorinated compound, such as a chlorosilane, the precursor is used in admixture with hydrogen gas, preferably in at least a 1:1 atomic ratio of hydrogen to chlorine.

Optionally, the precursor is free of chlorine. Free of chlorine means that the precursor contains less than 1 wt %, preferably less than 0.1 wt %, preferably less than 0.01 wt % of chlorine-containing compounds.

The gaseous silicon-containing precursors in step (b) may be used either in pure form (or substantially pure form) or as a diluted mixture with an inert carrier gas, such as nitrogen or argon. Preferably step (b) comprises contacting the porous particles with a gas comprising at least 30 vol %, or at least 40 vol %, or at least 50 vol %, or at least 60 vol %, or at least 70 vol %, or at least 80 vol %, or at least 90 vol %, or at least 95 vol %, or at least 97 vol %, or at least 99 vol % of the silicon-containing precursor based on the total volume of the gas.

The presence of oxygen in step (b) should be avoided to prevent undesired oxidation of the deposited electroactive material, in accordance with conventional procedures for working in an inert atmosphere. Preferably, the oxygen content is less than 0.01 vol %, more preferably less than 0.001 vol % based on the total volume of gas used in step (b).

The temperature in step (b) is preferably in the range from 340 to 500° C., or from 350 to 480° C., or from 350 to 450° C., or from 350 to 420° C., or from 350 to less than 400° C., or from 355 to 395° C., or from 360 to 390° C., or from 360 to 385° C., or from 360 to 380° C. More preferably, the temperature in step (b) is in the range from 340 to less than 400° C., or from 370 to 395° C.

The pressure in step (b) is preferably in the range from 1 to 5000 kPa, or from 20 to 500 kPa, or from 40 to 200 kPa, or from 50 to 150 kPa, or from 60 to 120 kPa, or from 80 to 100 kPa. Preferably, the pressure in at step (b) is maintained at no more than 200 kPa, or at no more than 150 kPa, or at no more than 120 kPa, or at no more than 110 kPa, or at no more than 100 kPa, or at no more than 90 kPa, or at no more than 80 kPa.

References to the pressure in any step of the claimed process refer to the absolute pressure in the reaction zone, which may comprise any suitable form of reactor vessel.

The deposition of electroactive materials by CVI results in the elimination of by-products, particularly by-product gases such as hydrogen. Step (b) preferably further comprises the separation of by-products from the particles formed in step (b). Separation of by-products may be effected by flushing the reactor with an inert gas and/or by evacuating the reactor by reducing the pressure. For example, the separation of by-products from the particles formed in step (b) may be effected by evacuating the reactor to a pressure of less than 100 kPa, or less than 80 kPa, or less than 60 kPa, or less than 40 kPa, or less than 20 kPa, or less than 10 kPa, or less than 5 kPa, or less than 2 kPa, or less than 1 kPa. Evacuating the reactor to low pressure may be effective not only to remove by-products in the gas phase, but also to desorb any by-products that may be adsorbed onto the surfaces of the deposited silicon.

The temperature in step (c) may be greater than the temperature in step (b). Preferably, the temperature in step (c) is at least 20° C., or at least 40° C., or at least 60° C., or at least 80° C., or at least 100° C., or at least 120° C., or at least 140° C., or at least 150° C. greater than the temperature in step (b).

For example, the temperature in step (c) may be at least 450° C., or at least 500° C., or at least 510° C., or at least 520° C., or at least 540° C., or at least 560° C., or at least 580° C., or at least 600° C., or at least 610° C., or at least 620° C., or at least 630° C., or at least 640° C., or at least 650° C. Preferably, the temperature in step (c) is at least 500° C. More preferably, the temperature in step (c) is at least 510° C. More preferably, the temperature in step (c) is at least 520° C. Preferably, the temperature in step (c) is no more than 900° C., or no more than 850° C., or no more than 800° C., or no more than 750° C., or no more than 700° C., or no more than 680° C., or no more than 660° C., or no more than 650° C. More preferably, the temperature in step (c) is no more than 750° C. More preferably, the temperature in step (c) is no more than 700° C.

The temperature in step (c) may be in the range from 400° C. to 900° C., or from 500° C. to 900° C., or from 600° C. to 900° C. The temperature in step (c) may be in the range from 500° C. to 800° C., or from 510° C. to 800° C., or from 520° C. to 750° C., or from 540° C. to 700° C., or from 560° C. to 680° C., or from 580° C. to 660° C., or from 600° C. to 650° C. Preferably, the temperature in step (c) is in the range from 500° C. to 750° C. More preferably, the temperature in step (c) is in the range from 510° C. to 750° C. More preferably, the temperature in step (c) is in the range or from 520° C. to 700° C.

The duration of step (c) is preferably at least 1 minute, or at least 2 minutes, or at least 5 minutes, or at least 10 minutes, or at least 15 minutes, or at least 20 minutes, or at least 30 minutes, or at least 45 minutes, or at least 1 hour, or at least 2 hours. More preferably, the duration of step (c) is at least 30 minutes. More preferably, the duration of step (c) is at least 1 hour. More preferably, the duration of step (c) is at least 90 minutes. Preferably, the duration of step (c) is no more than 72 hours, or no more than 48 hours, or no more than 24 hours, or no more than 12 hours, or no more than 6 hours, or no more than 5 hours, or no more than 4 hours, or no more than 3 hours. More preferably, the duration of step (c) is no more than 24 hours. More preferably, the duration of step (c) is no more than 12 hours. More preferably, the duration of step (c) is no more than 6 hours.

The duration of step (c) may be in the range from 1 minute to 72 hours, or from 2 minutes to 48 hours, or from 5 minutes to 24 hours, or from 10 minutes to 12 hours, or from 15 minutes to 6 hours, or from 20 minutes to 5 hours, or from 30 minutes to 4 hours, or from 1 hour to 4 hours, or from 1 hour to 3 hours. Preferably, the duration of step (c) is in the range from 30 minutes to 24 hours. More preferably, the duration of step (c) is in the range from 1 hour to 12 hours. More preferably, the duration of step (c) is in the range from 90 minutes to 6 hours.

Step (c) preferably comprises maintaining the particles from step (b) above a lower threshold temperature TL of at least 400° C. for a time period t. More preferably, step (c) comprises maintaining the particles from step (b) between the lower threshold temperature TL and an upper threshold temperature TU for the time period t.

The lower threshold temperature TL in step (c) may be 450° C., or 500° C., or 510° C., or 520° C., or 540° C., or 560° C., or 580° C., or 600° C., or 610° C., or 620° C., or 630° C., or 640° C., or 650° C. Preferably, the lower threshold temperature TL in step (c) is 500° C. More preferably, the lower threshold temperature TL in step (c) is 510° C. More preferably, the lower threshold temperature TL in step (c) is 520° C. Preferably, the upper threshold temperature TU in step (c) is 900° C., or 850° C., or 800° C., or 750° C., or 700° C., or 695° C., or 680° C., or 660° C., or 650° C. More preferably, the upper threshold temperature TU in step (c) is 750° C. More preferably, the upper threshold temperature TU in step (c) is 700° C.

The lower threshold temperature TL and the upper threshold temperature TU may respectively be 400° C. and 900° C., or 500° C. and 900° C., or 600° C. and 900° C. The lower threshold temperature TL and the upper threshold temperature TU may respectively be 500° C. and 800° C., or 510° C. and 800° C., or 520° C. and 750° C., or 540° C. and 700° C., or 560° C. and 680° C., or 580° C. and 660° C., or 600° C. and 650° C. Preferably, the lower threshold temperature TL and the upper threshold temperature TU are respectively 500° C. and 750° C. More preferably, the lower threshold temperature TL and the upper threshold temperature TU are respectively 510° C. and 750° C. More preferably, the lower threshold temperature TL and the upper threshold temperature TU are respectively 520° C. and 700° C.

The time period t is preferably at least 1 minute, or at least 2 minutes, or at least 5 minutes, or at least 10 minutes, or at least 15 minutes, or at least 20 minutes, or at least 30 minutes, or at least 45 minutes, or at least 1 hour, or at least 2 hours. More preferably, the time period t is at least 30 minutes. More preferably, the time period t is at least 1 hour. More preferably, the time period t is at least 90 minutes. Preferably, the time period t is no more than 72 hours, or no more than 48 hours, or no more than 24 hours, or no more than 12 hours, or no more than 6 hours, or no more than 5 hours, or no more than 4 hours, or no more than 3 hours. More preferably, the time period t is no more than 24 hours. More preferably, the time period t is no more than 12 hours. More preferably, the time period t is no more than 6 hours.

The time period t may be in the range from 1 minute to 72 hours, or from 2 minutes to 48 hours, or from 5 minutes to 24 hours, or from 10 minutes to 12 hours, or from 15 minutes to 6 hours, or from 20 minutes to 5 hours, or from 30 minutes to 4 hours, or from 1 hour to 4 hours, or from 1 hour to 3 hours. Preferably, the time period t is in the range from 30 minutes to 24 hours. More preferably, the time period t is in the range from 1 hour to 12 hours. More preferably, the time period t is in the range from 90 minutes to 6 hours.

Step (c) is carried out in the presence of an inert gas. An inert gas refers herein to any gas that does not undergo reaction under the conditions of step (c). Accordingly, gases that undergo reaction under the conditions of step (c) are not present during step (c). Preferably, the inert gas is selected from nitrogen and the noble gases, in particular argon. Optionally, the inert gas may comprise hydrogen. The inert gas may be selected from the group consisting of nitrogen, argon, helium and combinations thereof. Step (c) may be carried out in the presence of hydrogen and a gas selected from the group consisting of nitrogen, argon, helium and combinations thereof.

Preferably, step (c) is carried out:
(i) At a temperature in the range from 400° C. to 900° C.;
(ii) For a period of from 1 minute to 72 hours; and
(iii) In the presence of an inert gas, optionally comprising hydrogen.

Preferably, step (c) is carried out:
(i) At a temperature in the range from 500° C. to 900° C.;
(ii) For a period of from 30 minutes to 4 hours; and
(iii) In the presence of an inert gas, optionally comprising hydrogen.

Preferably, step (c) is carried out:
(i) At a temperature in the range from 600° C. to 900° C.;
(ii) For a period of from 1 hour to 4 hours; and
(iii) In the presence of an inert gas, optionally comprising hydrogen.

Preferably, step (c) is carried out:
(i) At a temperature in the range from 500° C. to 750° C.;
(ii) For a period of from 30 minutes to 24 hours; and
(iii) In the presence of an inert gas, optionally comprising hydrogen.

Preferably, step (c) is carried out:
(i) At a temperature in the range from 500° C. to 750° C.;
(ii) For a period of from 1 hour to 12 hours; and
(iii) In the presence of an inert gas, optionally comprising hydrogen.

Preferably, step (c) is carried out:
(i) At a temperature in the range from 500° C. to 700° C.;
(ii) For a period of from 90 minutes to 6 hours; and
(iii) In the presence of an inert gas, optionally comprising hydrogen.

Preferably, step (c) is carried out:
(i) At a temperature in the range from 510° C. to 750° C.;
(ii) For a period of from 30 minutes to 24 hours; and
(iii) In the presence of an inert gas, optionally comprising hydrogen.

Preferably, step (c) is carried out:
(i) At a temperature in the range from 510° C. to 750° C.;
(ii) For a period of from 1 hour to 12 hours; and
(iii) In the presence of an inert gas, optionally comprising hydrogen.

Preferably, step (c) is carried out:
(i) At a temperature in the range from 510° C. to 700° C.;
(ii) For a period of from 90 minutes to 6 hours; and
(iii) In the presence of an inert gas, optionally comprising hydrogen.

Preferably, step (c) is carried out:
(i) At a temperature in the range from 520° C. to 750° C.;
(ii) For a period of from 30 minutes to 24 hours; and
(iii) In the presence of an inert gas, optionally comprising hydrogen.

Preferably, step (c) is carried out:
(i) At a temperature in the range from 520° C. to 750° C.;
(ii) For a period of from 1 hour to 12 hours; and
(iii) In the presence of an inert gas, optionally comprising hydrogen.

Preferably, step (c) is carried out:
(i) At a temperature in the range from 520° C. to 700° C.;
(ii) For a period of from 90 minutes to 6 hours; and
(iii) In the presence of an inert gas, optionally comprising hydrogen.

Preferably, step (c) is carried out:
(i) With a lower threshold temperature TL of 500° C. and an upper threshold temperature TU of 750° C.;
(ii) For a time period t of from 30 minutes to 24 hours; and
(iii) In the presence of an inert gas, optionally comprising hydrogen.

Preferably, step (c) is carried out:
(i) With a lower threshold temperature TL of 500° C. and an upper threshold temperature TU of 750° C.;
(ii) For a time period t of from 1 hour to 12 hours; and
(iii) In the presence of an inert gas, optionally comprising hydrogen.

Preferably, step (c) is carried out:
(i) With a lower threshold temperature TL of 500° C. and an upper threshold temperature TU of 700° C.;
(ii) For a time period t of from 90 minutes to 6 hours; and
(iii) In the presence of an inert gas, optionally comprising hydrogen.

Preferably, step (c) is carried out:
(i) With a lower threshold temperature TL of 510° C. and an upper threshold temperature TU of 750° C.;
(ii) For a time period t of from 30 minutes to 24 hours; and
(iii) In the presence of an inert gas, optionally comprising hydrogen.

Preferably, step (c) is carried out:
(i) With a lower threshold temperature TL of 510° C. and an upper threshold temperature TU of 750° C.;
(ii) For a time period t of from 1 hour to 12 hours; and
(iii) In the presence of an inert gas, optionally comprising hydrogen.

Preferably, step (c) is carried out:
(i) With a lower threshold temperature TL of 510° C. and an upper threshold temperature TU of 700° C.;
(ii) For a time period t of from 90 minutes to 6 hours; and
(iii) In the presence of an inert gas, optionally comprising hydrogen.

Preferably, step (c) is carried out:
(i) With a lower threshold temperature TL of 520° C. and an upper threshold temperature TU of 750° C.;
(ii) For a time period t of from 30 minutes to 24 hours; and
(iii) In the presence of an inert gas, optionally comprising hydrogen.

Preferably, step (c) is carried out:
(i) With a lower threshold temperature TL of 520° C. and an upper threshold temperature TU of 750° C.;
(ii) For a time period t of from 1 hour to 12 hours; and
(iii) In the presence of an inert gas, optionally comprising hydrogen.

Preferably, step (c) is carried out:
(i) With a lower threshold temperature TL of 520° C. and an upper threshold temperature TU of 700° C.;
(ii) For a time period t of from 90 minutes to 6 hours; and
(iii) In the presence of an inert gas, optionally comprising hydrogen.

Step (c) preferably comprises subjecting the particles from step (b) to heat treatment at a temperature of at least 400° C. and in the presence of an inert gas to promote the formation of Si—Si bonds in the silicon domains, to promote the formation of covalent bonds between silicon and the internal surfaces of the porous particle framework while avoiding formation of silicon carbide, to reduce the surface area of the silicon domains, and/or to increase the chemical stability of the silicon domains.

Steps (b) and (c) may be carried out in same reactor vessel. Alternatively, step (b) may be carried out in a first reactor vessel and the particles formed in step (b) may then be transferred to a second reactor vessel for carrying out step (c). The particles may be maintained at a temperature that is less than the temperature in step (b) during transfer to the second reactor vessel. Preferably, the particles are maintained at a temperature of at least 50° C. during transfer to the second reactor vessel.

In one aspect, the invention provides a process for preparing composite particles, the process comprising the steps of:
(a) providing a plurality of porous particles comprising micropores and/or mesopores;
(b) contacting the porous particles with a silicon-containing precursor at a temperature effective to cause deposition of a plurality of nanoscale silicon domains in the pores of the porous particles;
(c) maintaining the particles from step (b) above a lower threshold temperature TL of at least 400° C. for a time period t.

Preferably, step (c) comprises maintaining the particles from step (b) between the lower threshold temperature TL and an upper threshold temperature TU for the time period t.

Preferably, the lower threshold temperature TL is 500° C., the upper threshold temperature TU is 700° C., and the time period t is from 90 minutes to 6 hours.

The above aspect of the invention may be optionally combined with any other features disclosed herein in connection with the first aspect of the invention.

The process of the invention optionally further comprises the step of:
(d) contacting the surface of the particles from step (c) with a passivating agent or contacting the particles from step (b) with a passivating agent prior to step (c).

As defined herein, a passivating agent is a compound of mixture of compounds which is able to react with the surface of the silicon deposited in step (b) to form a modified surface. In particular, a passivating agent as defined herein is a material which is able to react with the surfaces of the silicon to further reduce the surface energy thereof.

Preferably, step (d) is carried out after step (c). As discussed above, one effect of step (c) is to reopen pore spaces that were previously obstructed or capped by silicon nanostructures, such that the pore spaces are accessible to passivating gases, thus allowing for a more extensive passivation of the silicon surfaces and the elimination of hydrogen-terminated silicon surfaces.

One type of passivation layer is a native oxide layer. A native oxide layer may be formed, for example, by exposing the silicon surface to a passivating agent selected from air or another oxygen containing gas. The passivation layer may comprise a silicon oxide of the formula SiOₓ, wherein 0<x≤2. The silicon oxide is preferably amorphous silicon oxide. The formation of a native oxide layer is exothermic and therefore requires careful process control to prevent overheating or even combustion of the particulate material. In the case that the passivating agent is an oxygen-containing gas, step (c) may comprise cooling the material formed in step (b) to a temperature below 300° C., preferably below 200° C., optionally below 100° C., prior to contacting the silicon surfaces with the oxygen containing gas.

Another type of passivation layer is a nitride layer that is formed, for example, by exposing the silicon surfaces to a passivating agent selected from ammonia or another nitrogen containing molecule. The passivation layer may comprise a silicon nitride of the formula SiNₓ, wherein 0<x≤4/3. The silicon nitride is preferably amorphous silicon nitride. A nitride layer may be formed by contacting the silicon surfaces with ammonia at a temperature in the range from 200-700° C., preferably from 400-700° C., more preferably from 400-600° C. The temperature may then be increased if necessary into the range of 500 to 1,000° C. to form a nitride surface (e.g. a silicon nitride surface of the formula SiNx, wherein x≤4/3). Nitride passivation may be preferred to oxide passivation. As sub-stoichiometric nitrides (such as SiN_{X}, wherein 0<x≤4/3) are conductive, nitride passivation layers may function as a conductive network that allows for faster charging and discharging of the electroactive material. Phosphine may also be used as a passivating agent, as a phosphorus analog of ammonia.

Another type of passivation layer is an oxynitride layer that is formed, for example, by exposing the silicon surfaces to a passivating agent comprising ammonia (or another nitrogen containing molecule) and oxygen gas. The passivation layer may comprise a silicon oxynitride of the formula SiO_{X}Ny, wherein 0<x<2, 0<y<4/3, and 0<(2x+3y)≤4). The silicon nitride is preferably amorphous silicon oxynitride.

Another type of passivation layer is a carbide layer. The passivation layer may comprise a silicon carbide of the formula SiCₓ, wherein 0<x≤1. The silicon carbide is preferably amorphous silicon carbide. A carbide layer may be formed by contacting the silicon surfaces with a passivating agent selected from carbon containing precursors, e.g. methane or ethylene at elevated temperatures, e.g in the range from 250 to 700° C. At lower temperatures, covalent bonds are formed between the silicon surfaces and the carbon-containing precursors, which are the converted to a monolayer of crystalline silicon carbide as the temperature is increased. The silicon carbide may have the formula SiCx, wherein 0<x≤1.

Other suitable passivating agents include compounds comprising an alkene, alkyne or carbonyl functional group, more preferably a terminal alkene, terminal alkyne, aldehyde or ketone group.

Preferred passivating agents include one or more compounds of the formulae:

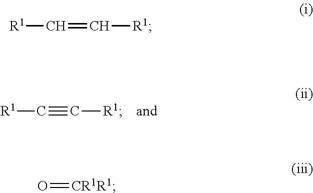

wherein each R¹ independently represents H or an unsubstituted or substituted aliphatic or aromatic hydrocarbyl group having from 1 to 20 carbon atoms, or wherein two R¹ groups form an unsubstituted or substituted ring structure comprising from 3 to 8 carbon atoms in the ring.

Particularly preferred passivating agents include one or more compounds of the formulae:

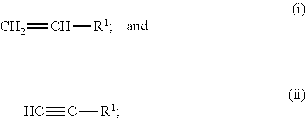

wherein R¹ is as defined above. Preferably, R¹ is unsubstituted.

Examples of suitable passivating agents include ethylene, propylene, 1-butene, butadiene, 1-pentene, 1,4-pentadiene, 1-hexene, 1-octene, styrene, divinylbenzene, acetylene, phenylacetylene, norbornene, norbornadiene and bicyclo[2.2.2]oct-2-ene. Optionally, mixtures of different passivating agents may also be used.

It is believed that passivating agents comprising an alkene, alkyne or carbonyl group undergo an insertion reaction with Si—H groups at the silicon surface to form a covalently passivated surface which is resistant to oxidation by air. The passivation reaction between the silicon surface and the passivating agent may therefore be understood as a form of hydrosilylation, as shown schematically below.

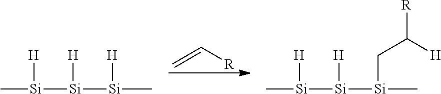

Other suitable passivating agents include compounds including an active hydrogen atom bonded to oxygen, nitrogen, sulphur or phosphorus. For example, the passivating agent may be an alcohol, amine, thiol or phosphine. Reaction of the group —XH with hydride groups at the silicon surfaces is understood to result in elimination of H₂ and the formation of a direct bond between X and the silicon surfaces.

Suitable passivating agents in this category include compounds of the formula

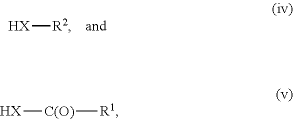

wherein X represents O, S, NR¹ or PR¹; each R¹ is independently as defined above; and R² represents an unsubstituted or substituted aliphatic or aromatic hydrocarbyl group having from 1 to 20 carbon atoms, or R¹ and R² together form an unsubstituted or substituted ring structure comprising from 3 to 8 carbon atoms in the ring.

Preferably X represents O or NH.

Preferably R² represents an optionally substituted aliphatic or aromatic group having from 2 to 10 carbon atoms. Amine groups may also be incorporated into a 4-10 membered aliphatic or aromatic ring structure, as in pyrrolidine, pyrrole, imidazole, piperazine, indole, or purine.

Another suitable passivating agent is water. For example, the silicon surface may be exposed to water vapour. Alternatively, the particles from step (c) may be immersed in water. Optionally, passivation using one or more of the passivating agents disclosed above may be followed by passivation with water.

Preferably, step (d) is carried out with a passivating agent other than air.

Contacting of the electroactive material with the passivating agent in step (d) may be carried out at a temperature in the range of 25 to 500° C., preferably at a temperature in the range of from 50 to 450° C., more preferably from 100 to 400° C.

The process of the invention optionally further comprises the step of:
(e) depositing a lithium ion permeable material into the pores and/or onto the outer surface of the composite particles from step (c) or step (d).

Preferably, the lithium-ion permeable material is a pyrolytic carbon material and step (e) comprises combining the particles from step (c) or step (d) with a pyrolytic carbon precursor; and heating the pyrolytic carbon precursor to a temperature effective to cause the deposition of a conductive pyrolytic carbon material into the pores and/or onto the outer surface of the composite particles. In the case that step (d) is included in the process, step (e) may optionally be performed before or after step (d). In every case, step (e) is performed after step (c).

The pyrolytic carbon precursor is preferably a hydrocarbon. Suitable hydrocarbons include polycyclic hydrocarbons comprising from 10 to 25 carbon atoms and optionally from 1 to 3 heteroatoms, optionally wherein the polyaromatic hydrocarbon is selected from naphthalene, substituted naphthalenes such as di-hydroxynaphthalene, anthracene, tetracene, pentacene, fluorene, acenapthene, phenanthrene, fluoranthrene, pyrene, chrysene, perylene, coronene, fluorenone, anthraquinone, anthrone and alkyl-substituted derivatives thereof. Suitable pyrolytic carbon precursors also include bicyclic monoterpenoids, optionally wherein the bicyclic monoterpenoid is selected from camphor, borneol, eucalyptol, camphene, careen, sabinene, thujene and pinene. Further suitable pyrolytic carbon precursors include C₂-C₁₀ hydrocarbons, optionally wherein the hydrocarbons are selected from alkanes, alkenes, alkynes, cycloalkanes, cycloalkenes, and arenes, for example methane, ethylene, propylene, limonene, styrene, cyclohexane, cyclohexene, α-terpinene and acetylene. Other suitable pyrolytic carbon precursors include phthalocyanine, sucrose, starches, graphene oxide, reduced graphene oxide, pyrenes, perhydropyrene, triphenylene, tetracene, benzopyrene, perylenes, coronene, and chrysene. A preferred carbon precursor is acetylene.

A suitable temperature for the deposition of a pyrolytic carbon material in step (e) is in the range from 300 to 800° C., or from 400 to 700° C. For example, the temperature may be no more than 680° C. or no more than 660° C., or no more than 640° C. or no more than 620° C., or no more than 600° C., or no more than 580° C., or no more than 560° C., or no more than 540° C., or no more than 520° C., or no more than 500° C. The minimum temperature will depend on the type of carbon precursor that is used. Preferably, the temperature is at least 300° C., or at least 350° C., or at least 400° C., or at least 450° C., or at least 500° C.

The carbon-containing precursors used in step (e) may be used in pure form, or diluted mixture with an inert carrier gas, such as nitrogen or argon. For instance, the carbon-containing precursor may be used in an amount in the range from 0.1 to 100 vol %, or 0.5 to 20 vol %, or 1 to 10 vol %, or 1 to 5 vol % based on the total volume of the precursor and the inert carrier gas.

In the case that a pyrolytic carbon material is deposited in step (e), the same compound may function as both a passivating agent in step (d) and the pyrolytic carbon precursor in step (e). For example, if styrene is selected as the pyrolytic carbon precursor, then it will also function as a passivating agent if the particles from step (b) are not exposed to another passivating agent prior to contact with styrene. In this case, passivation and deposition of the conductive carbon material in steps may be carried out simultaneously, for example at a temperature in the range of from 300-700° C. Alternatively, passivation and deposition of the conductive carbon material may be carried out sequentially, with the same material as the passivating agent and the pyrolytic carbon precursor, but wherein step (e) is carried out at a higher temperature than, and following, the passivation in step (d). For example, passivation in step (d) may be carried out at a temperature in the range of from 25° C. to less than 300° C., and deposition of pyrolytic carbon may be carried out at a temperature in the range from 300-700° C. These two steps may suitably be carried out sequentially by increasing the temperature while maintaining contact with the compound that functions as both a passivating agent and the pyrolytic carbon precursor. At lower temperatures (e.g. in the range of 25° C. to <300° C.) passivation will be the primary process. As the temperature is increased (e.g. to 300-700° C.) the deposition of pyrolytic carbon will ensue.

A range of different silicon loadings in the composite particles may be obtained using the process of the invention. The composite particles obtained according to the method of the invention preferably comprise at least 26 wt % silicon, or at least 28 wt % silicon, or at least 30 wt % silicon, or at least 32 wt % silicon, or at least 34 wt % silicon, or at least 36 wt % silicon, or at least 38 wt % silicon, or at least 40 wt % silicon, or at least 42 wt % silicon, or at least 44 wt % silicon.

The amount of electroactive material (e.g. silicon) in the composite particles is preferably selected such that at least 20% and up to 90% of the internal pore volume of the porous particles is occupied by the electroactive material following step (c). For example, the electroactive material may occupy from 20% to 80%, or from 25% to 75%, or from 30% to 70%, or from 35 to 65%, or from 40 to 60%, or from 45% to 55% of the internal pore volume of the porous particles. Within these preferred ranges, the remaining pore volume of the porous particles is effective to accommodate expansion of the electroactive material during charging and discharging, without a large excess pore volume which does not contribute to the volumetric capacity of the particulate particles. However, the amount of electroactive material is also not so high as to impede effective lithiation due to inadequate metal-ion diffusion rates or due to inadequate expansion volume resulting in mechanical resistance to lithiation.

In the case that the electroactive material is silicon, the amount of silicon in the composite particles can be related to the available pore volume in the porous particles by the requirement that the mass ratio of silicon to the porous particles is in the range from [0.5×P¹ to 1.9×P¹]:1, wherein P¹ is a dimensionless quantity having the magnitude of the total pore volume of micropores and mesopores in the porous particles, as expressed in cm³/g (e.g. if the porous particles have a total volume of micropores and mesopores of 1.2 cm³/g, then P¹=1.2). This relationship takes into account the density of silicon and the pore volume of the porous particles to define a weight ratio of silicon at which the pore volume is around 20% to 82% occupied. Preferably, the weight ratio of silicon deposited in step (b) to the porous particles is in the range from [0.6×P¹ to 1.8×P¹]:1 or from [0.7×P¹ to 1.7×P¹]:1, or from [0.8×P¹ to 1.6×P¹]:1.

The amount of silicon in the composite particles can be determined by elemental analysis. Preferably, elemental analysis is used to determine the elemental composition of the porous particles alone and the composition of the composite particles.

Silicon content is preferably determined by ICP-OES (Inductively coupled plasma-optical emission spectrometry). A number of ICP-OES instruments are commercially available, such as the iCAP® 7000 series of ICP-OES analysers available from ThermoFisher Scientific. The carbon content of the composite particles and of the porous carbon particles alone (as well as the hydrogen, nitrogen and oxygen content if required) are preferably determined by IR absorption. A suitable instrument for determining carbon, hydrogen, nitrogen and oxygen content is the TruSpec® Micro elemental analyser available from Leco Corporation.

Preferably at least 90 wt %, more preferably at least 95 wt %, even more preferably at least 98 wt % of the electroactive material in the composite particles is located within the internal pore volume of the porous particles such that there is no or very little electroactive material located on the external surfaces of the composite particles. As discussed above, deposition of electroactive material in a CVI process occurs at the surfaces of the porous particles. In view of the very high internal surface area of the porous particles, the reaction kinetics of the CVI process ensure that deposition of the electroactive material occurs almost entirely within the pores of the porous particles. The internal deposition of the electroactive material is further improved by the requirement that the pressure in step (b) is maintained at less than 200 kPa, or within the more preferred pressure ranges discussed above.

Composite particles obtained by the process of the invention can be characterised by their performance under thermogravimetric analysis (TGA) in air. This method of analysis relies on the principle that a weight gain is observed when electroactive materials are oxidized in air and at elevated temperature.

As defined herein, “surface silicon” is calculated from the initial mass increase in the TGA trace from a minimum between 150° C. and 500° C. to the maximum mass measured in the temperature range between 550° C. and 650° C., wherein the TGA is carried out in air with a temperature ramp rate of 10° C./min. This mass increase is assumed to result from the oxidation of surface silicon and therefore allows the percentage of surface silicon as a proportion of the total amount of silicon to be determined according to the following formula:

$$Y = 1.875 \times [ ( {M}_{max} - {M}_{min} ) / {M}_{f} ] \times 100 \%$$

Wherein Y is the percentage of surface silicon as a proportion of the total silicon in the sample, Mₘₐₓ is the maximum mass of the sample measured in the temperature range between 550° C. to 650° C., Mₘᵢₙ is the minimum mass of the sample above 150° C. and below 500° C., and M_{f} is the mass of the sample at completion of oxidation at 1400° C. For completeness, it will be understood that 1.875 is the molar mass ratio of SiO₂ to O₂ (i.e. the mass ratio of SiO₂ formed to the mass increase due to the addition of oxygen). Typically, the TGA analysis is carried out using a sample size of 10 mg±2 mg.

It has been found that reversible capacity retention over multiple charge/discharge cycles is considerably improved when the surface silicon as determined by the TGA method described above is at least 20 wt % of the total amount of silicon in the material. Preferably at least 22 wt %, or at least 25 wt %, at least 30 wt % of the silicon, or at least 35 wt % of the silicon, or at least 40 wt % of the silicon, or at least 45 wt % of the silicon is surface silicon as determined by thermogravimetric analysis (TGA).

In addition to the surface silicon content, the silicon-containing composite particles obtained by the process of the invention preferably have a low content of coarse bulk silicon as determined by TGA. Coarse bulk silicon is defined herein as silicon which undergoes oxidation above 800° C. as determined by TGA, wherein the TGA is carried out in air with a temperature ramp rate of 10° C./min. The coarse bulk silicon content is therefore determined according to the following formula:

$$Z = 1.875 \times [ ( {M}_{f} - {M}_{800} ) / {M}_{f} ] \times 100 \%$$

Wherein Z is the percentage of unoxidized silicon at 800° C., M₈₀₀ is the mass of the sample at 800° C. and M_{f} is the mass of ash at completion of oxidation at 1400° C. For the purposes of this analysis, it is assumed that any mass increase above 800° C. corresponds to the oxidation of silicon to SiO₂ and that the total mass at completion of oxidation is SiO₂.

Silicon that undergoes oxidation above 800° C. is less desirable. Preferably, no more than 10 wt %, or no more than 8 wt %, or no more than 6 wt %, or no more than 5 wt %, or no more than 4 wt %, or no more than 3 wt %, or no more than 2 wt %, or no more than 1.5 wt % of the silicon is coarse bulk silicon as determined by TGA.

Preferably, at least 30 wt % of the silicon is surface silicon and no more than 10 wt % of the silicon is coarse bulk silicon, wherein both are determined by TGA. More preferably, at least 35 wt % of the silicon is surface silicon and no more than 8 wt % of the silicon is coarse bulk silicon, wherein both are determined by TGA. More preferably, at least 40 wt % of the silicon is surface silicon and no more than 5 wt % of the silicon is coarse bulk silicon, wherein both are determined by TGA. More preferably, at least 45 wt % of the silicon is surface silicon and no more than 2 wt % of the silicon is coarse bulk silicon, wherein both are determined by TGA.

The composite particles obtained according to the process of the invention preferably have a BET surface area of no more than 300 m²/g, or no more than 250 m²/g, or no more than 200 m²/g, or no more than 150 m²/g. More preferably, no more than 100 m²/g, or no more than 80 m²/g, or no more than 60 m²/g, or no more than 40 m²/g, or no more than 30 m²/g, or no more than 25 m²/g, or no more than 20 m²/g, or no more than 15 m²/g, or no more than 10 m²/g, or no more than 5 m²/g. In general, a low BET surface area is preferred in order to minimize the formation of solid electrolyte interphase (SEI) layers at the surface of the composite particles during the first charge-discharge cycle of an anode. However, a BET surface area which is excessively low results in unacceptably low charging rate and capacity due to the inaccessibility of the bulk of the electroactive material to metal ions in the surrounding electrolyte. The BET surface area is preferably at least 0.1 m²/g, or at least 1 m²/g, or at least 2 m²/g, or at least 5 m²/g. For instance, the BET surface area of the composite particles may be in the range from 0.1 to 100 m²/g, or from 0.1 to 80 m²/g, or from 0.5 to 60 m²/g, or from 0.5 to 40 m²/g, or from 1 to 30 m²/g, or from 1 to 25 m²/g, or from 2 to 20 m²/g.

The ratio of BET surface area of the particles formed in step (c) to BET surface area of the particles formed in step (b) may be at least 1.1:1, or at least 1.2:1, or at least 1.3:1, or at least 1.4:1, or at least 1.5:1, or at least 2:1, or at least 3:1, or at least 4:1, or at least 5:1.

The ratio of BET surface area of the particles formed in step (c) to BET surface area of the particles formed in step (b) may be no more than 15:1, or no more than 14:1, or no more than 13:1, or no more than 12:1.

The ratio of total pore volume of micropores and mesopores as measured by gas adsorption of the particles formed in step (c) to total pore volume of micropores and mesopores as measured by gas adsorption of the particles formed in step (b) may be at least 2:1, or at least 3:1, or at least 4:1, or at least 5:1, or at least 6:1, or at least 7:1, or at least 8:1.

The ratio of total pore volume of micropores and mesopores as measured by gas adsorption of the particles formed in step (c) to total pore volume of micropores and mesopores as measured by gas adsorption of the particles formed in step (b) may be no more than 20:1, or no more than 19:1, or no more than 18:1, or no more than 17:1, or no more than 16:1, or no more than 15:1.

The ratio of total hydrogen content of the particles formed in step (c) to total hydrogen content of the particles formed in step (b) may be no more than 0.8:1, or no more than 0.7:1, or no more than 0.6:1, or no more than 0.5:1.

The ratio of total hydrogen content of the particles formed in step (c) to total hydrogen content of the particles formed in step (b) may be at least 0.1:1, or at least 0.2:1, or at least 0.3:1.

The process of the reaction may be carried out using any reactor that is capable of contacting solids and gases at elevated temperature. The porous particles and the forming composite particles may be present in the reactor in the form of a static bed of particles, or in the form of a moving or agitated bed of particles.

In a second aspect, the invention provides composite particles that are obtainable according to the process of the first aspect of the invention.

In a third aspect of the invention, there is provided a composition comprising composite particles according to the second aspect of the invention and at least one other component. In particular, there is provided a composition comprising composite particles according to the second aspect of the invention and at least one other component selected from: (i) a binder; (ii) a conductive additive; and (iii) an additional particulate electroactive material. The composition according to the third aspect of the invention is useful as an electrode composition, and thus may be used to form the active layer of an electrode.

The composition may be a hybrid electrode composition which comprises the composite particles and at least one additional particulate electroactive material. Examples of additional particulate electroactive materials include graphite, hard carbon, silicon, tin, germanium, aluminium and lead. The at least one additional particulate electroactive material is preferably selected from graphite and hard carbon, and most preferably the at least one additional particulate electroactive material is graphite.

In the case of a hybrid electrode composition, the composition preferably comprises from 3 to 60 wt %, or from 3 to 50 wt %, or from 5 to 50 wt %, or from 10 to 50 wt %, or from 15 to 50 wt %, of the composite particles according to the second aspect of the invention, based on the total dry weight of the composition.

The at least one additional particulate electroactive material is suitably present in an amount of from 20 to 95 wt %, or from 25 to 90 wt %, or from 30 to 75 wt % of the at least one additional particulate electroactive material.

The at least one additional particulate electroactive material preferably has a D₅₀ particle diameter in the range from 10 to 50 μm, preferably from 10 to 40 μm, more preferably from 10 to 30 μm and most preferably from 10 to 25 μm, for example from 15 to 25 μm.

The D₁₀ particle diameter of the at least one additional particulate electroactive material is preferably at least 5 μm, more preferably at least 6 μm, more preferably at least 7 μm, more preferably at least 8 μm, more preferably at least 9 μm, and still more preferably at least 10 μm.

The D₉₀ particle diameter of the at least one additional particulate electroactive material is preferably up to 100 μm, more preferably up to 80 μm, more preferably up to 60 μm, more preferably up to 50 μm, and most preferably up to 40 μm.

The at least one additional particulate electroactive material is preferably selected from carbon-comprising particles, graphite particles and/or hard carbon particles, wherein the graphite and hard carbon particles have a D₅₀ particle diameter in the range from 10 to 50 μm. Still more preferably, the at least one additional particulate electroactive material is selected from graphite particles, wherein the graphite particles have a D₅₀ particle diameter in the range from 10 to 50 μm.

The composition may also be a non-hybrid (or “high loading”) electrode composition which is substantially free of additional particulate electroactive materials. In this context, the term “substantially free of additional particulate electroactive materials” should be interpreted as meaning that the composition comprises less than 15 wt %, preferably less than 10 wt %, preferably less than 5 wt %, preferably less than 2 wt %, more preferably less than 1 wt %, more preferably less than 0.5 wt % of any additional electroactive materials (i.e. additional materials which are capable of inserting and releasing metal ions during the charging and discharging of a battery), based on the total dry weight of the composition.

A “high-loading” electrode composition of this type preferably comprises at least 50 wt %, or at least 60 wt %, or at least 70 wt %, or at least 80 wt %, or at least 90 wt % of the composite particles of the second aspect of the invention, based on the total dry weight of the composition.

The composition may optionally comprise a binder. A binder functions to adhere the composition to a current collector and to maintain the integrity of the composition. Examples of binders which may be used in accordance with the present invention include polyvinylidene fluoride (PVDF), polyacrylic acid (PAA) and alkali metal salts thereof, modified polyacrylic acid (mPAA) and alkali metal salts thereof, carboxymethylcellulose (CMC), modified carboxymethylcellulose (mCMC), sodium carboxymethylcellulose (Na-CMC), polyvinylalcohol (PVA), alginates and alkali metal salts thereof, styrene-butadiene rubber (SBR) and polyimide. The composition may comprise a mixture of binders. Preferably, the binder comprises polymers selected from polyacrylic acid (PAA) and alkali metal salts thereof, and modified polyacrylic acid (mPAA) and alkali metal salts thereof, SBR and CMC.

The binder may suitably be present in an amount of from 0.5 to 20 wt %, preferably 1 to 15 wt %, preferably 2 to 10 wt % and most preferably 5 to 10 wt %, based on the total dry weight of the composition.

The binder may optionally be present in combination with one or more additives that modify the properties of the binder, such as cross-linking accelerators, coupling agents and/or adhesive accelerators.

The composition may optionally comprise one or more conductive additives. Preferred conductive additives are non-electroactive materials that are included so as to improve electrical conductivity between the electroactive components of the composition and between the electroactive components of the composition and a current collector. The conductive additives may be selected from carbon black, carbon fibers, carbon nanotubes, graphene, acetylene black, ketjen black, metal fibers, metal powders and conductive metal oxides. Preferred conductive additives include carbon black and carbon nanotubes.

The one or more conductive additives may suitably be present in a total amount of from 0.5 to 20 wt %, preferably 1 to 15 wt %, preferably 2 to 10 wt % and most preferably 5 to 10 wt %, based on the total dry weight of the composition.

In a fourth aspect, the invention provides an electrode comprising composite particles according to the second aspect of the invention and a current collector, wherein the composite particles are in electrical contact with the current collector. The particulate material used to prepare the electrode of the fourth aspect of the invention may be in the form of a composition according to the third aspect of the invention.

As used herein, the term current collector refers to any conductive substrate that is capable of carrying a current to and from the electroactive particles in the composition. Examples of materials that can be used as the current collector include copper, aluminium, stainless steel, nickel, titanium and sintered carbon. Copper is a preferred material. The current collector is typically in the form of a foil or mesh having a thickness of between 3 to 500 μm. The particulate materials of the invention may be applied to one or both surfaces of the current collector to a thickness which is preferably in the range from 10 μm to 1 mm, for example from 20 to 500 μm, or from 50 to 200 μm.

The electrode of the fourth aspect of the invention may be fabricated by combining the particulate material of the invention with a solvent and optionally one or more viscosity modifying additives to form a slurry. The slurry is then cast onto the surface of a current collector and the solvent is removed, thereby forming an electrode layer on the surface of the current collector. Further steps, such as heat treatment to cure any binders and/or calendaring of the electrode layer may be carried out as appropriate. The electrode layer suitably has a thickness in the range from 20 μm to 2 mm, preferably 20 μm to 1 mm, preferably 20 μm to 500 μm, preferably 20 μm to 200 μm, preferably 20 μm to 100 μm, preferably 20 μm to 50 μm.

Alternatively, the slurry may be formed into a freestanding film or mat comprising the particulate material of the invention, for instance by casting the slurry onto a suitable casting template, removing the solvent and then removing the casting template. The resulting film or mat is in the form of a cohesive, freestanding mass that may then be bonded to a current collector by known methods.

The electrode of the fourth aspect of the invention may be used as the anode of a metal-ion battery. Thus, in a fifth aspect, the present invention provides a rechargeable metal-ion battery comprising the electrode of the fourth aspect as the anode.

The metal ions are preferably lithium ions. More preferably, the rechargeable metal-ion battery of the invention is a lithium-ion battery, and the cathode active material is capable of releasing and accepting lithium ions.

The cathode of the rechargeable metal-ion battery typically comprises a current collector and a cathode active material capable of releasing and reabsorbing metal ions. The cathode active material is preferably a metal oxide-based composite. Examples of suitable cathode active materials include LiCoO₂, LiCo_{0.99}Al_{0.01}O₂, LiNiO₂, LiMnO₂, LiCo_{0.5}Ni_{0.5}O₂, LiCo_{0.7}Ni_{0.3}O₂, LiCo_{0.8}Ni_{0.2}O₂, LiCo_{0.82}Ni_{0.18}O₂, LiCo_{0.8}Ni_{0.15}Al_{0.05}O₂, LiNi_{0.4}Co_{0.3}Mn_{0.3}O₂ and LiNi_{0.33}Co_{0.33}Mn_{0.34}O₂. The cathode current collector is generally of a thickness of between 3 to 500 μm. Examples of materials that can be used as the cathode current collector include aluminium, stainless steel, nickel, titanium and sintered carbon.

A suitable electrolyte is a non-aqueous electrolyte containing a metal salt, e.g. a lithium salt, and may include, without limitation, non-aqueous electrolytic solutions, solid electrolytes and inorganic solid electrolytes. Examples of non-aqueous electrolyte solutions that can be used include non-protic organic solvents such as propylene carbonate, ethylene carbonate, butylene carbonates, dimethyl carbonate, diethyl carbonate, gamma butyrolactone, 1,2-dimethoxyethane, 2-methyltetrahydrofuran, dimethylsulfoxide, 1,3-dioxolane, formamide, dimethylformamide, acetonitrile, nitromethane, methylformate, methyl acetate, phosphoric acid triesters, trimethoxymethane, sulfolane, methyl sulfolane and 1,3-dimethyl-2-imidazolidinone.

Examples of organic solid electrolytes include polyethylene derivatives polyethyleneoxide derivatives, polypropylene oxide derivatives, phosphoric acid ester polymers, polyester sulfide, polyvinylalcohols, polyvinylidine fluoride and polymers containing ionic dissociation groups.

Examples of inorganic solid electrolytes include nitrides, halides and sulfides of lithium salts such as Li₅NI₂, Li₃N, LiI, LiSiO₄, Li₂SiS₃, Li₄SiO₄, LiOH and Li₃PO₄.

The lithium salt is suitably soluble in the chosen solvent or mixture of solvents. Examples of suitable lithium salts include LiCl, LiBr, LiI, LiClO₄, LiBF₄, LiBC₄O₈, LiPF₆, LiCF₃SO₃, LiAsF₆, LiSbF₆, LiAlCl₄, CH₃SO₃Li and CF₃SO₃Li.

Where the electrolyte is a non-aqueous organic solution, the metal-ion battery is preferably provided with a separator interposed between the anode and the cathode. The separator is typically formed of an insulating material having high ion permeability and high mechanical strength. The separator typically has a pore diameter of between 0.01 and 100 μm and a thickness of between 5 and 300 μm. Examples of suitable electrode separators include a micro-porous polyethylene film.

The separator may be replaced by a polymer electrolyte material and in such cases the polymer electrolyte material is present within both the composite anode layer and the EXAMPLES

### Example 1

Silicon carbon composite Sample A (30 g) was loaded into a furnace tube. The furnace tube was sealed and then purged with nitrogen (0.3 L/min) for 30 min. The furnace tube was heated to target temperature (650° C.) under nitrogen (0.3 L/min) over 97 min.

The silicon carbon composite was then annealed at 650° C. for 180 min under nitrogen (0.5 L/min). The furnace temperature was then cooled to room temperature under nitrogen (0.5 L/min).

Subsequently, the annealed material was passivated with 100% acetylene gas (0.75 L/min), for 60 min. The furnace was then cooled to room temperature under a flow of acetylene (0.16 L/min) and nitrogen (0.35 L/min).

A final passivation step was then carried out at room temperature under a flow of nitrogen (0.2 L/min) and air (0.3 L/min) for 35 min, followed by a flow of air (0.5 L/min) for 90 min.

The resulting powder was submitted for characterisation as Sample B.

Sample C was prepared using the methods described for Sample B and the conditions outlined in Table 1 below. Characterisation of Samples A-C is provided in Table 2 below.

Sample A is the silicon carbon composite used to make Samples B-C.

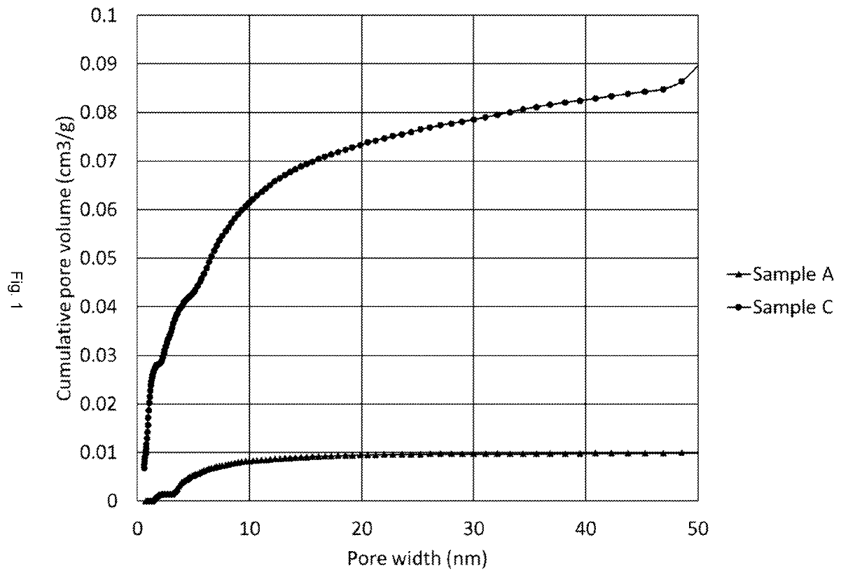

The cumulative pore volumes of Samples A and C are shown in FIG. 1.

TABLE 1
Annealing conditions for Samples B and C

| | | Annealing | | |
|---|---|---|---|---|
| | Annealing | temperature/ | Annealing | Passivation |
| Sample | atmosphere | ° C. | time/min | conditions |
| B | Nitrogen | 650 | 180 | Acetylene, |
| | | | | room |
| | | | | temperature, |
| | | | | 30 min |
| C | Nitrogen | 650 | 90 | Nitrogen (0.2 |
| | | | | L/min) and air |
| | | | | (0.3 L/min), |
| | | | | room |
| | | | | temperature, |
| | | | | 35 min, |
| | | | | followed by air |
| | | | | (0.5 L/min), |
| | | | | room |
| | | | | temperature, |
| | | | | 90 min |

TABLE 2
Characterisation of Samples A-C

| | | Hydrogen | Silicon | Surface silicon |
|---|---|---|---|---|
| | BET Surface | content/ | content/ | content/ |
| Sample | area/m²/g | % w/w | % w/w | % w/w |
| A | 11.4 | 0.97 | 55.0 | 47.7 |
| B | 69.2 | 0.77 | 49.9 | 41.0 |
| C | 125.7 | 0.58 | 50.7 | 43.0 |

### Example 2

Silicon carbon composite Sample 0 (40 g) was loaded into a rotary kiln tube. The rotary kiln tube was sealed and then purged with nitrogen (0.3 L/min) for 30 min. The furnace tube was heated to target temperature (520° C.) under nitrogen (0.3 L/min) over 80 mins and allowed to stabilise for 10 min.

Nitrogen flow was increased to 0.66 L/min, rotation increased to 50 rpm and the silicon carbon composite was annealed for 180 min. The furnace was then cooled to room temperature.

The annealed material was then passivated at room temperature under a flow of nitrogen (0.2 L/min) and air (0.3 L/min) for 30 min, followed by a flow of air (0.5 L/min) for 30 min.

The resulting powder was submitted for characterisation as Sample E.

Samples F-G were prepared using the methods described for Sample E and the conditions outlined in Table 3 below. Characterisation of Samples D-G is provided in Table 4 below. Sample D is the silicon carbon composite used to make Samples E-G.

TABLE 3
Annealing conditions for Samples E-G

| | Annealing | Annealing | Annealing |
|---|---|---|---|
| Sample | atmosphere | temperature/° C. | time/min |
| E | Nitrogen | 520 | 180 |
| F | Nitrogen | 520 | 90 |
| G | Nitrogen (0.25 | 520 | 180 |
| | L/min) and | | |
| | hydrogen (0.25 | | |
| | L/min) mixture | | |

TABLE 4
Characterisation of Samples D-G

| | | Hydrogen | Silicon | Surface silicon |
|---|---|---|---|---|
| | BET Surface | content/ | content/ | content/ |
| Sample | area/m²/g | % w/w | % w/w | % w/w |
| D | 23.3 | 0.80 | 50.4 | 63.0 |
| E | 23.5 | 0.39 | 47.4 | 55.0 |
| F | 21.7 | 0.34 | 48.0 | 59.0 |
| G | 21.4 | 0.52 | 49.3 | 64.0 |

As shown in Tables 2 and 4, the content of hydrogen is reduced as a result of annealing.

Addition of hydrogen to the annealing atmosphere (as in Sample G) results in increased retention of hydrogen within the structure and thus, a surface silicon content more similar to baseline silicon carbon composite Sample D.

### Example 3

Silicon carbon composite Sample A (30 g) was loaded into a furnace tube. The furnace tube was sealed and then purged with nitrogen (0.3 L/min) for 30 min. The furnace tube was heated to target temperature (600° C.) under nitrogen (0.3 L/min) over 97 min.

The silicon carbon composite was then annealed at 600° C. for 30 min under nitrogen (0.5 L/min). The furnace temperature was then cooled to 400° C.

Subsequently, the annealed material was passivated with 100% ethylene gas (0.75 L/min), for 60 min. The furnace was then cooled to room temperature under a flow of ethylene (0.16 L/min) and nitrogen (0.35 L/min).

A final passivation step was then carried out at room temperature under a flow of nitrogen (0.2 L/min) and air (0.3 L/min) for 35 min, followed by a flow of air (0.5 L/min) for 90 min.

The resulting black-grey powder was sieved through a 53 micron mesh sieve and submitted for characterisation as Sample H.

Samples I-K were prepared using the methods described for Sample H and the conditions outlined in Table 5 below. Characterisation of Samples H-K is provided in Table 6 below. Sample A is the silicon carbon composite used to make Samples H-K.

TABLE 5
Annealing and passivation conditions for Samples H-K

| | | Annealing | | |
|---|---|---|---|---|
| | Annealing | temperature/ | Annealing | Passivation |
| Sample | atmosphere | ° C. | time/min | conditions |
| H | Nitrogen | 600 | 30 | Ethylene, |
| | | | | 400° C., 60 min |
| I | Nitrogen | 600 | 120 | Ethylene, |
| | | | | 400° C., 240 min |
| J | Nitrogen | 650 | 120 | Ethylene, |
| | | | | 400° C., 240 min |
| K | Nitrogen | 750 | 30 | Ethylene, |
| | | | | 400° C., 60 min |

TABLE 6
Characterisation of Samples H-K

| | | Hydrogen | Silicon | Surface silicon |
|---|---|---|---|---|
| | BET surface | content/ | content/ | content/ |
| Sample | area/m²/g | % w/w | % w/w | % w/w |
| H | 11.6 | 0.61 | 51.4 | 57 |
| I | 11.3 | 0.56 | 51.2 | 53 |
| J | 46.3 | 0.75 | 50.6 | 47 |
| K | 132 | 0.46 | 50.5 | 36 |

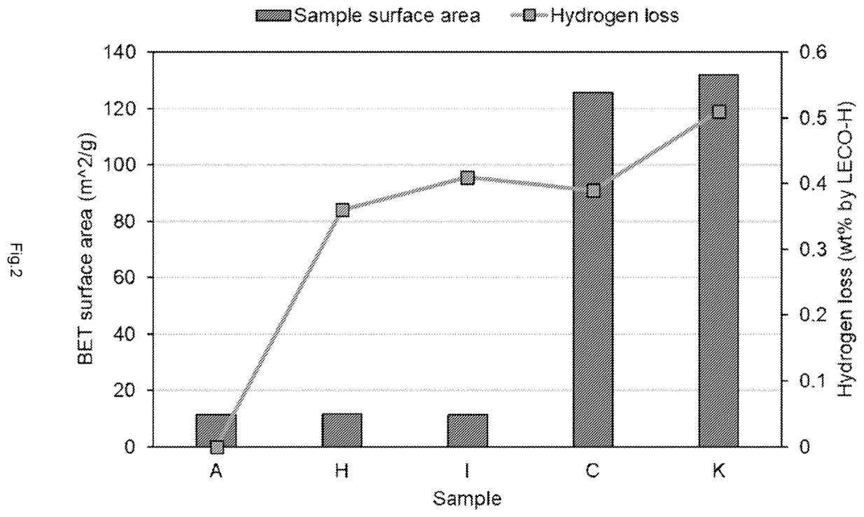

The BET surface area and reduction in LECO-H % (relative to that of Sample A) of Samples A, H, I, C and K are shown in FIG. 2. Thermal treatment increases the gas accessible pore volume due to the volume contraction of the silicon as a result of hydrogen desorption (reduced LECO-H % in Samples H, I, C and K vs A).

### Example 4

Silicon carbon composite Sample L (31 g) was loaded into a rotary kiln tube. The rotary kiln tube was sealed and then purged with nitrogen (0.3 L/min) for 30 min. The furnace tube was heated to target temperature (650° C.) under nitrogen (0.3 L/min) over 97 mins and allowed to stabilise for 10 min. The silicon carbon composite was annealed for 180 min.

The furnace was then cooled to 520° C. and the annealed material was contacted with a mixture of acetylene (0.35 L/min) and nitrogen (0.79 L/min) for 90 min, followed by nitrogen only (0.5 L/min) for 10 min to form a carbon coating. The material was then cooled to room temperature.

The carbon coated material was then passivated at room temperature under a flow of nitrogen (0.2 L/min) and air (0.3 L/min) for 30 min, followed by a flow of air (0.5 L/min) for 30 min.

The resulting powder was submitted for characterisation as Sample M.

Sample N was prepared using an analogous procedure to Sample M, except that the annealed material was carbon coated at 650° C.

Sample O was prepared using an analogous procedure to Sample M, except that Sample A was used as the starting material.

TABLE 6
Annealing and carbon coating conditions for Samples M-O

| | | Annealing | | Carbon |
|---|---|---|---|---|
| | Annealing | temperature/ | Annealing | coating |
| Sample | atmosphere | ° C. | time/min | conditions |
| M | Nitrogen | 650 | 180 | Acetylene, |
| | | | | 520° C., 90 min |
| N | Nitrogen | 650 | 180 | Acetylene, |
| | | | | 650° C., 90 min |
| O | Nitrogen | 650 | 180 | Acetylene, |
| | | | | 520° C., 90 min |

TABLE 7
Characterisation of Samples L-O

| | | Hydrogen | Silicon | Surface silicon |
|---|---|---|---|---|
| | BET surface | content/ | content/ | content/ |
| Sample | area/m²/g | % w/w | % w/w | % w/w |
| L | 46.2 | 0.84 | 51.3 | 60 |
| M | 12.9 | 0.42 | 47.6 | 41 |
| N | 12 | 0.53 | 47.6 | 41 |
| O | 9.6 | 0.41 | 51.0 | 39 |

As shown in Table 7, the combination of both annealing and carbon coating enable significant reductions in surface area and hydrogen content.

### Reference Example 5

Silicon carbon composite Sample A (30 g) was loaded into a furnace tube. The furnace tube was sealed and then purged with nitrogen (0.3 L/min) for 30 min. The furnace tube was heated to target temperature (650° C.) under nitrogen (0.3 L/min) over 97 min and allowed to stabilise for 10 min.

Subsequently, the composite particles were contacted with a mixture of acetylene (0.35 L/min) and nitrogen (0.75 L/min) for 90 min, followed by nitrogen only (0.5 L/min) for 15 min to form a carbon coating. The material was then cooled to room temperature.

The carbon coated material was then passivated at room temperature under a flow of nitrogen (0.2 L/min) and air (0.3 L/min) for 30 min, followed by a flow of air (0.5 L/min) for 30 min to give Sample P.

TABLE 8
Characterisation of Sample P

| | | Hydrogen | Silicon | Surface silicon |
|---|---|---|---|---|
| | BET surface | content/ | content/ | content/ |
| Sample | area/m²/g | % w/w | % w/w | % w/w |
| P | 5.45 | 0.37 | 47.9 | 21.7 |

As shown in Table 8, carbon coating using acetylene in the absence of a separate annealing step yields reduced surface area but also results in significant structural degradation with a marked decrease in the surface silicon content in Sample P as compared to Sample O.

### Example 6—Cell Testing

Electrodes were manufactured by adding silicon-carbon composite particles to a dispersion of carbon black in CMC binder in a Thinky™ mixer. SBR binder was added to give a CMC:SBR ratio of 1:1, yielding a slurry with a weight ratio of Si—C composite material: CMC/SBR:carbon black of 70%:16%:14%. The slurry was cast onto a 10 μm thick copper substrate (current collector) and dried at 50° C. for 10 minutes, followed by further drying at 110° C. for 12 hours to form a negative electrode with a coating density of 1.5-2.0±0.5 g/cm³.

Full pouch single layer cells were manufactured using this electrode as the negative electrode and a nickel manganese cobalt (NMC532) electrode as the positive electrode, with the electrodes balanced to a cathode to anode ratio of 0.9 based on their corresponding areal capacities in mAh/cm². The pouch cells also included a porous polyethylene separator and an electrolyte comprising 1 M LiPF₆ in a 1:5:14 (v/v/v) of FEC:EC:EMC (fluoroethylene carbonate/ethylene carbonate/ethylene methyl carbonate) containing 3 wt % VC (vinylene carbonate) was added to the cell before it was sealed.

The pouch single layer cells were left to soak overnight. For the initial formation cycle the cells were charged at constant current applied at a rate of C/25 with a cut off voltage of 4.3 V. When the cut off voltage was reached, a constant voltage of 4.3 V was applied until a cut off current of C/100 was reached. The cell was rested for 10 minutes then discharged at constant current of C/25 with a cut off voltage of 2.75 V. The cell was then rested for 10 minutes, completing formation.

After this formation cycle, the cells were de-gassed and then re-connected for cycling testing. Cycling was carried out under stressed conditions at 45° C. 1 C current was used corresponded to the discharge capacity after formation. Cells were charged at constant current applied at a rate of C/2 with a cut off voltage of 4.3 V. When the cut off was reached, a constant voltage of 4.3 V was applied until a cut off current of C/40 was reached, followed by a rest time of 5 minutes. The cells were then discharged at constant current of C/2 with a cut off voltage of 2.75 V, with a rest time of 5 minutes. This charge-discharge procedure was repeated to determine the number of cycles before the cells reached 80% of capacity retention, i.e. number cycles before the discharge capacity of the cell drops to 0.8×(1^{st} discharge capacity after formation cycle).

The charge (lithiation) and discharge (delithiation) capacities for each cycle are calculated per unit mass of the silicon-carbon composite material. The results are shown in Table 9.

TABLE 9
Cell Cycling at 45° C.

| Sample | Cycles to 80% capacity retention |
|---|---|
| A | 129 |
| O | 193 |
| L | 200 |
| M | 335 |
| N | 276 |

As shown in Table 9, cell cycling under stressed conditions (45° C.) shows a marked effect of the annealing process described herein on the cycle life of the electroactive material. Non-annealed samples (A, L) are shown to lose reversible capacity significantly more quickly than the annealed Samples O (relative to A), and M and N (both relative to L).

1. A process for preparing composite particles, the process comprising the steps of:
(a) providing a plurality of porous particles comprising micropores and/or mesopores;
(b) contacting the porous particles with a silicon-containing precursor at a temperature effective to cause deposition of a plurality of silicon domains in the pores of the porous particles;
(c) subjecting the particles from step (b) to heat treatment at a temperature of at least 400° C. and in the presence of an inert gas.

2. A process according to claim 1, wherein the total pore volume of micropores and mesopores in the porous particles as measured by gas adsorption is at least 0.4 cm³/g, or at least 0.5 cm³/g, or at least 0.6 cm³/g, or at least 0.65 cm³/g, or at least 0.7 cm³/g, or at least 0.75 cm³/g, or at least 0.8 cm³/g.

3. (canceled)

4. A process according to claim 1, wherein the PD₉₀ pore diameter of the porous particles is no more than 20 nm, or no more than 15 nm, or no more than 12 nm, or no more than 10 nm, or no more than 8 nm, or no more than 6 nm, or no more than 5 nm.

5. (canceled)

6. A process according to claim 1, wherein the PD₅₀ pore diameter of the porous particles is no more than 10 nm, or no more than 8 nm, or no more than 6 nm, or no more than 5 nm, or no more than 4 nm, or no more than 3 nm, or no more than 2.5 nm, or no more than 2 nm, or no more than 1.9 nm, or no more than 1.8 nm, or no more than 1.7 nm, or no more than 1.6 nm.

7.-15. (canceled)

16. A process according to claim 1, wherein the temperature in step (b) is in the range from 340 to 500° C., or from 350 to 480° C., or from 350 to 450° C., or from 350 to 420° C., or from 350 to less than 400° C., or from 355 to 395° C., or from 360 to 390° C., or from 360 to 385° C., or from 360 to 380° C., preferably wherein the temperature in step (b) is in the range from 340 to less than 400° C., or from 370 to 395° C.

17. (canceled)

18. A process according to claim 1, wherein the temperature in step (c) is greater than the temperature in step (b), optionally, wherein the temperature in step (c) is at least 20° C., or at least 40° C., or at least 60° C., or at least 80° C., or at least 100° C., or at least 120° C., or at least 140° C., or at least 150° C. greater than the temperature in step (b).

19. A process according to claim 1, wherein the temperature in step (c) is at least 450° C., or at least 500° C., or at least 510° C., or at least 520° C., or at least 540° C., or at least 560° C., or at least 580° C., or at least 600° C., or at least 610° C., or at least 620° C., or at least 630° C., or at least 640° C., or at least 650° C., preferably wherein the temperature in step (c) is at least 500° C., more preferably wherein the temperature in step (c) is at least 510° C., more preferably wherein the temperature in step (c) is at least 520° C.

20. A process according to claim 1, wherein the temperature in step (c) is no more than 900° C., or no more than 850° C., or no more than 800° C., or no more than 750° C., or no more than 700° C., or no more than 680° C., or no more than 660° C., or no more than 650° C., preferably wherein the temperature in step (c) is no more than 750° C., more preferably wherein the temperature in step (c) is no more than 700° C.

21. A process according to claim 1, wherein step (c) is carried out for a period of at least 1 minute, or at least 2 minutes, or at least 5 minutes, or at least 10 minutes, or at least 15 minutes, or at least 20 minutes, or at least 30 minutes, or at least 45 minutes, or at least 1 hour, or at least 2 hours, preferably wherein step (c) is carried out for a period of at least 30 minutes, more preferably wherein step (c) is carried out for a period of at least 1 hour, more preferably wherein step (c) is carried out for a period of at least 90 minutes.

22. A process according to claim 1, wherein step (c) is carried out for a period of no more than 72 hours, or no more than 48 hours, or no more than 24 hours, or no more than 12 hours, or no more than 6 hours, or no more than 5 hours, or no more than 4 hours, or no more than 3 hours, preferably wherein step (c) is carried out for a period of no more than 24 hours, more preferably wherein step (c) is carried out for a period of no more than 12 hours, more preferably wherein step (c) is carried out for a period of no more than 6 hours.

23. A process according to claim 1, wherein step (c) comprises maintaining the particles from step (b) above a lower threshold temperature TL of at least 400° C. for a time period t, preferably step (c) comprises maintaining the particles from step (b) between the lower threshold temperature TL and an upper threshold temperature TU for the time period t.

24. A process according to claim 23, wherein the lower threshold temperature TL is 500° C., the upper threshold temperature TU is 700° C., and the time period t is from 90 minutes to 6 hours.

25. A process according to claim 1, further comprising the step of:
(d) contacting the surface of the particles from step (c) with a passivating agent or contacting the particles from step (b) with a passivating agent prior to step (c).

26. A process according to claim 25, wherein the passivating agent is selected from (i) an oxygen-containing gas; (ii) ammonia; (iii) a gas comprising ammonia and oxygen; (iv) phosphine; and (v) water; (vi) R¹—CH═CH—R¹: (vii) R¹—C≡C—R¹: (viii) O═CR¹R¹: (ix) HX—R², and (x) HX—C(O)—R¹,
wherein X represents O, S, NR¹ or PR¹; and
wherein each R¹ independently represents H or an unsubstituted or substituted aliphatic or aromatic hydrocarbyl group having from 1 to 20 carbon atoms, or wherein two R¹ groups form an unsubstituted or substituted ring structure comprising from 3 to 8 carbon atoms in the ring:
wherein R² represents an unsubstituted or substituted aliphatic or aromatic hydrocarbyl group having from 1 to 20 carbon atoms, or wherein R¹ and R² together form an unsubstituted or substituted ring structure comprising from 3 to 8 carbon atoms in the ring.

27. (canceled)

28. A process according to claim 1, further comprising the step of:
(e) depositing a lithium ion permeable material into the pores and/or onto the outer surface of the composite particles from step (c) or step (d).

29. A process according to claim 28, wherein the lithium-ion permeable material is a pyrolytic carbon material and wherein step (e) comprises combining the particles from step (c) or step (d) with a pyrolytic carbon precursor; and heating the pyrolytic carbon precursor to a temperature effective to cause the deposition of a conductive pyrolytic carbon material into the pores and/or onto the outer surface of the composite particles, optionally wherein step (e) is performed before step (d).

30. A process according to claim 1, wherein the composite particles comprise at least 26 wt % silicon, or at least 28 wt % silicon, or at least 30 wt % silicon, or at least 32 wt % silicon, or at least 34 wt % silicon, or at least 36 wt % silicon, or at least 38 wt % silicon, or at least 40 wt % silicon, or at least 42 wt % silicon, or at least 44 wt % silicon.

31. A process according to claim 1, wherein the weight ratio of silicon deposited in step (b) to the porous particles is in the range from [0.50×P¹ to 1.9×P¹]:1, or from [0.6×P¹ to 1.8×P¹]:1 or from [0.7×P¹ to 1.7×P¹]:1, or from [0.8×P¹ to 1.6×P¹]:1, wherein P¹ is a dimensionless number having the same value as the total pore volume of micropores and mesopores in the porous particles as measured by gas adsorption as expressed in cm³/g.

32. A process according to claim 1, wherein at least 20 wt %, or at least 22 wt %, or at least 25 wt %, or at least 30 wt %, or at least 35 wt %, or at least 40 wt % of the silicon, or at least 45 wt % of the silicon in the composite particles is surface silicon as determined by thermogravimetric analysis (TGA).

33. A process according to claim 1, wherein no more than 10 wt % of the silicon, or no more than 8 wt % of the silicon, or no more than 6 wt % of the silicon, or no more than 5 wt %, or no more than 4 wt %, or no more than 3 wt %, or no more than 2 wt % or no more than 1.5 wt % of the silicon in the composite particles is coarse bulk silicon as determined by thermogravimetric analysis (TGA).

34.-37. (canceled)
